(19) United States
(12) Patent Application Publication
(10) Pub. No.: US 2008/0017655 A1
(43) Pub. Date: Jan. 24, 2008

(54) Food container assembly

(76) Inventors: Shelly A. Martel, Pittsburgh, PA (US); James Auger, Airdrie (CA); Daniel Ward, Maineville, OH (US); Andrew Summerscales, Coraopolis, PA (US)

Correspondence Address: NOVA Chemicals Inc., Westpointe Center, 1550 Coraopolis Heights Road, Moon Township, PA, 15108, US

(21) Appl. No.: 11/489,176

(22) Filed: Jul. 19, 2006

(51) Int. Cl. A23L 1/00

(52) U.S. Cl. 220/912

(57) ABSTRACT

In accordance with the present invention, there is provided a food container assembly that includes a plurality of pre-packaged rigid containers, each containing an amount of food, that are vertically stacked within a tubular receptacle having oxygen (and optionally moisture) barrier properties. Each container (1) includes: (i) a bowl (11) having a closed bottom (14), an inner surface (17) defining a bowl interior (20), and an upper rim (23) defining an open top (26); (ii) a sleeve (29) having an outer surface (32) and a lower edge (35), and extending downwardly from upper rim (23) of bowl (11); (iii) an amount of food (44) residing within bowl interior (20); and (iv) a removable polymer film (47) sealingly engaging upper rim (23) of bowl (11), thereby sealing open top (26) of bowl (11) and containing food (44) within bowl interior (20). The plurality of containers (1) are arranged in a vertical stack (e.g., 2 or 3) having an outer edge (53). The assembly further includes a tubular receptacle (56) having a closed bottom (59), a closed top (62), and a sidewall (65) having an interior surface (68) defining an interior space (71). Tubular receptacle (56) is substantially continuous and has oxygen barrier properties. Interior space (71) is a substantially sealed interior space. The vertical stack (e.g., 2) resides within interior space (71) of tubular receptacle (56), and at least a portion of the outer edge (53) of vertical stack (56) abuts a portion of inner surface (68) of sidewall (65) thereof. The assembly of the present invention may be used to provide food for consumption by human and non-human animals, e.g., pets, such as dogs and cats.

### FIELD OF THE INVENTION

The present invention relates to a food container assembly that includes a plurality of rigid containers containing prepackaged food, that are vertically stacked within a tubular receptacle having oxygen barrier properties. Each container includes a bowl having an upper rim and a removable polymer film that sealingly engages the upper rim of the bowl, thereby containing an amount of food within the bowl. The containers are arranged in a vertical stack having an outer edge. The vertical stack resides within the sealed interior space of the tubular receptacle, such that at least a portion of the outer edge of the vertical stack abuts a portion of the inner sidewall surface of the tubular receptacle.

### BACKGROUND OF THE INVENTION

Single serving prepackaged foods that are ready-to-eat find wide applicability with both human and non-human animals, such as pets. Single serving prepackaged foods are popular in that they provide food that may be immediately consumed upon opening the package, or consumed with a minimum of preparation (e.g., the pre-application of heat by suitable means, such as a microwave oven). Situations in which there is insufficient time and/or resources (e.g., a kitchen) to prepare food, are particularly amenable to the use of prepackaged single servings of foods. Examples of such time and/or resource limited situations include camping, mountain climbing, traveling without stopping at restaurants, and military field operations.

In addition, prepackaged single servings of foods can be useful for purposes of providing dietary control, for example, relative to the food types ingested and/or caloric intake. Dietary control may be important for reasons of weight control, such as weight loss, weight gain and/or maintenance of a particular weight. Individuals afflicted with diabetes, for example, typically live with dietary restrictions as to the types of foods consumed, the amount of calories associated with those foods, and the times during the day when foods are to be consumed (e.g., relative to insulin injections).

The feeding of pets may also be achieved by means of single serving prepackaged foods. Prepackaged single servings of foods provide a pet owner with control over the types and amounts of foods provided to the pet at feeding times. In addition, prepackaged single servings of foods provide a pet owner with the ability to quickly, conveniently and efficiently feed their pet without having to first measure out and/or prepare the food.

Single serving prepackaged foods typically must be packaged and/or stored in such a way as to avoid spoilage and to correspondingly extend the shelf life of the foods contained therein. While storage at reduced temperatures generally extends the shelf life of food, such low temperature storage is not usually feasible in those situations where prepackaged foods are used (e.g., military field use). As such, prepackaged individual servings of foods are typically individually packaged in packaging materials which inhibit or slow the passage of spoiling agents (e.g., molecular oxygen and/or moisture) there-through. Packaging materials that serve to inhibit or slow the passage of food spoiling agents, such as molecular oxygen, are typically expensive due in part to raw materials and/or manufacturing costs.

Single serving prepackaged foods are well suited to provide some degree of control over or predictability relative to the types of foods consumed and the calories associated therewith. The sequence, however, at which single serving prepackaged foods are consumed (e.g., throughout the course of a single day and/or a week) is typically left to the consumer to lay out for themselves. For example, if different foods are to be consumed in a particular sequence throughout the day, the consumer typically must separately purchase and organize different single serving prepackaged foods for allocation and consumption throughout the day.

It would be desirable to develop new food container assemblies that provide a plurality of individual food servings, and desirably long storage stability or shelf life. In addition, it would be desirable that such newly developed food container assemblies be economically produced. Still further, it would be desirable that such newly developed food container assemblies optionally provide the consumer with the ability to control the sequence at which various prepackaged foods are served and consumed.

U.S. Pat. No. 4,716,844 discloses a feeding bowl assembly that includes a plurality of feeding bowls, which are detachably fixed to a supporting base sheet. The feeding bowls of U.S. '844 further include a hot seal foil that retains ready prepared food therein. The feeding bowls and base sheet of U.S. '844 may be wrapped together in shrink foil.

U.S. Pat. No. 3,653,362 discloses a pet feeder that includes: a rigid reusable holder; and a disposable liner that includes pet food. The disposable liner of U.S. '362 is disclosed as including a thin film sheet, which is heat sealed to a crown of the liner.

### SUMMARY OF THE INVENTION

In accordance with the present invention, there is provided a food container assembly comprising:
(a) a plurality of containers each comprising:
   (i) a bowl having a closed bottom, an inner surface defining a bowl interior, and an upper rim defining an open top;
   (ii) a sleeve having an outer surface and a lower edge, and extending downwardly from said upper rim of said bowl;
   (iii) an amount of food residing in said bowl interior; and
   (iv) a removable polymer film sealingly engaging (e.g., abutting) said upper rim of said bowl, thereby sealing said open top of said bowl and containing said amount of food within said bowl interior;
   wherein said plurality of containers are arranged in a vertical stack, said vertical stack having an outer edge; and
(b) a tubular receptacle having a closed bottom, a closed top, and a sidewall having an interior surface defining an interior space, said tubular receptacle being substantially continuous and being fabricated from a material having oxygen barrier properties, and said interior space being a substantially sealed interior space;
   wherein said vertical stack resides within said interior space of said tubular receptacle, and at least a portion of said outer edge of said vertical stack abutting a portion of said inner surface of said sidewall.

The features that characterize the present invention are pointed out with particularity in the claims, which are annexed to and form a part of this disclosure. These and other features of the invention, its operating advantages and the specific objects obtained by its use will be more fully understood from the following detailed description and accompanying drawings in which preferred embodiments of the invention are illustrated and described.

As used herein and in the claims, terms of orientation and position, such as “upper”, “lower”, “inner”, “outer”, “right”, “left”, “vertical”, “horizontal”, “top”, “bottom”, and similar terms, are used to describe the invention as oriented in the drawings. Unless otherwise indicated, the use of such terms is not intended to represent a limitation upon the scope of the invention, in that the invention may adopt alternative positions and orientations.

Unless otherwise indicated, all numbers or expressions, such as those expressing structural dimensions, quantities of ingredients, etc. used in the specification and claims are understood as modified in all instances by the term “about”.

### BRIEF DESCRIPTION OF THE DRAWINGS

FIG. 1 is a representative partially cutaway perspective view of a food container according to the present invention;

FIG. 2 is a representative sectional view of the food container of FIG. 1 showing the removable polymer film and tab;

FIG. 3 is a representative vertical stack of food containers according to the present invention in a top-to-top/bottom-to-bottom configuration;

FIG. 4 is a representative vertical stack of food containers according to the present invention in a top-to-bottom (or bottom-to-top) configuration;

FIG. 5 is a representative partial sectional view of a food container assembly according to the present invention;

FIG. 6 is a representative sectional view of two food containers in a top-to-top configuration with a blocking resistant film interposed between the removable polymer films thereof;

FIG. 7 is a representative sectional view of a food container in which an adhesive is interposed between the upper rim of the bowl and the removable polymer film;

FIG. 8 is a representative sectional view of the top portion of the tubular receptacle, which further includes a reversibly sealable opening having a tongue-in-grove configuration;

FIG. 9 is a representative sectional view of the top portion of the tubular receptacle, which further includes a reversibly sealable opening that includes an adhesive material;

FIG. 10(A) is a representative perspective view of a food container according to the present invention that includes a label on the sleeve;

FIG. 10(B) is a representative partial sectional view of the food container of FIG. 10(A) showing the label on the outer surface of the sleeve;

FIG. 11 is a representative partial sectional plan view of a food container assembly, according to the present invention, that includes three laterally positioned vertical stacks of food containers;

FIG. 12 is a representative sectional view of a food container, according to the present invention, in which the removable polymer film and a second polymer film together form a sealed pouch on the bowl interior side of the removable polymer film;

FIG. 13 is a representative sectional view of a portion of the bowl of the food container of FIG. 2, in which the bottom of the bowl further includes an anti-slip means that includes an adhesive layer and a protective film superposed there-over;

FIG. 14 is a representative sectional view similar to that of FIG. 13, in which the anti-slip means includes a non-slip elastomeric material;

FIG. 15 is a representative sectional view similar to that of FIG. 13, in which the anti-slip means includes the bottom of the bowl having an irregular exterior surface; and

FIG. 16 is a representative perspective view of a food container, according to the present invention, that includes a shrink-wrap applied label on the sleeve.

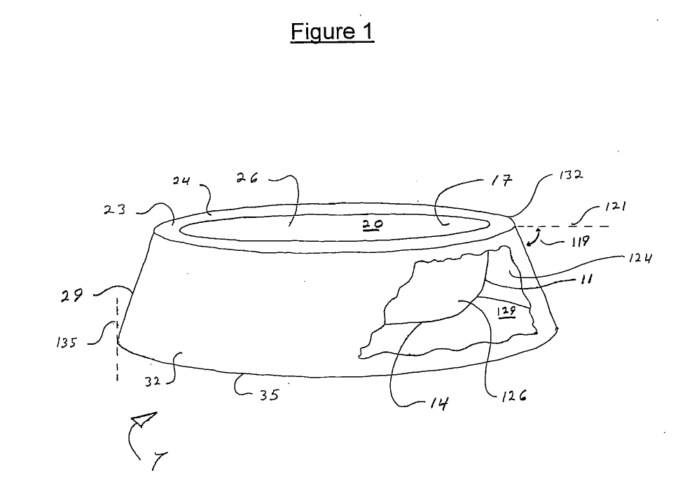

In FIGS. 1 through 16, like reference numerals designate the same components and structural features.

### DETAILED DESCRIPTION OF THE INVENTION

Now with reference to FIG. 1 of the drawings, there is depicted a container 1 of the food container assembly of the present invention. Food container 1 includes a bowl 11 having a closed bottom 14, and an inner surface 17 which defines a bowl interior 20. Container 1 also includes an upper rim 23 that defines an open top 26.

Container 1 includes a sleeve 29 that extends downwardly from upper rim 23 of bowl 11. Sleeve 29 has an exterior outer surface 32 and a lower edge 35. Sleeve 29 and outer surface 32 thereof may be continuous as depicted, or non-continuous (not shown). If non-continuous, sleeve 29 and outer surface 32 thereof may include perforations (not shown) and/or be composed of a plurality of sleeve portions (not shown) each extending downwardly from upper rim 23 of bowl 11. Correspondingly, lower edge 35 of sleeve 29 may be continuous as depicted, or non-continuous (not shown). If non-continuous, lower edge 35 may, for example, be composed of a plurality of lower edge portions (not shown) associated with each of a plurality of separate sleeve portions (not shown).

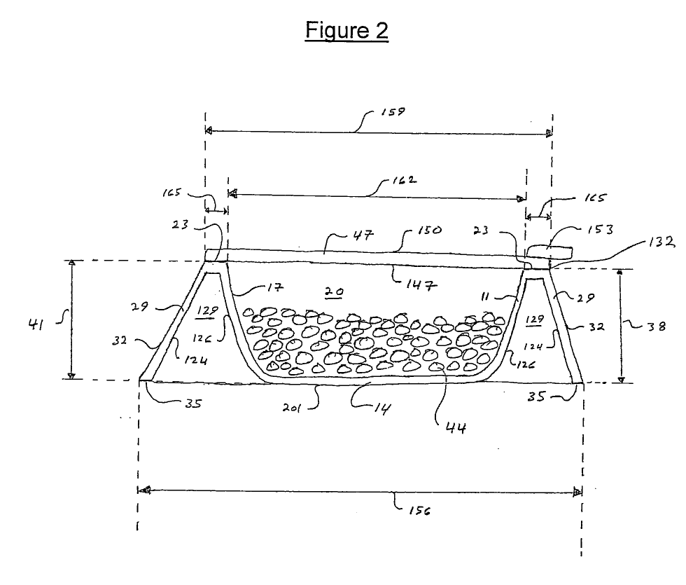

Container 1 may be supported by closed bottom 14 of bowl 11, or lower edge 35 of sleeve 29, or a combination of closed bottom 14 and lower edge 35. More particularly, and with reference to FIG. 2, upper rim 23 of bowl 11 has a vertical height 38 above lower edge 35 of sleeve 29, and a vertical height 41 above closed bottom 14 of bowl 11. When vertical height 38 is greater than vertical height 41, container 1 is supported by lower edge 35 of sleeve 29. When vertical height 41 is greater than vertical height 38, container 1 is supported by closed bottom 14 of bowl 11. When vertical height 38 and vertical height 41 are equivalent, container 1 is supported by a combination of closed bottom 14 of bowl 11 and lower edge 35 of sleeve 29 (as depicted in FIG. 2). Preferably, container 1 is supported by at least lower edge 35 of sleeve 29.

With reference to FIG. 2, each container 1 includes an amount of food 44 residing within bowl interior 20. As used herein and in the claims, the term “food” means edible material that may be ingested by a human or non-human animal, for purposes including, but not limited to nourishment, sustenance, non-nutritive appetite satiation and combinations thereof. Food 44 may include: organic materials, such as proteins, carbohydrates, fats and combinations thereof; optionally inorganic materials, such as minerals; optionally supplements, such as vitamins; and optionally medicines. Food 44 may be in the form of a solid, a liquid, a gel, or combinations thereof. When in a solid form, food 44 may assume any suitable shape or form. For example, food 44 may have a particulate/granulated form (e.g., nuggets of food), an elongated form (e.g., as is the case with spaghetti), a platelet form (e.g., disks or potato chip forms), a continuous form (e.g., as may be the case with cheese) or combinations thereof. Typically, food 44 is in a solid form, and in particular a solid particulate or granulated form.

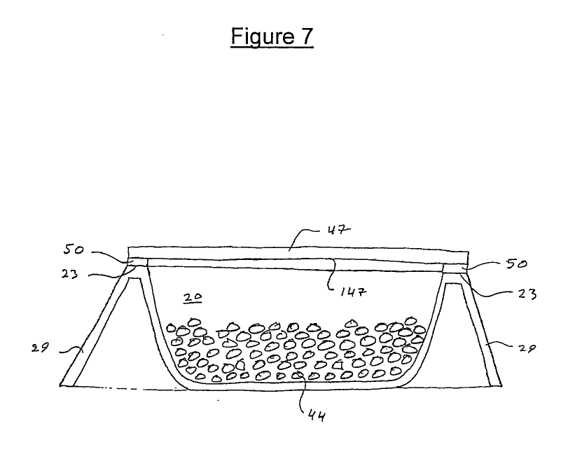

The food container also includes a removable polymer film 47 that engages sealingly with upper rim 23 of bowl 11. Removable polymer film 47 seals open top 26 of bowl 11 and thus serves to contain the amount of food 44 within bowl interior 20. Removable polymer film 47 may form a seal directly with upper rim 23, in which case polymer film 47 sealingly abuts upper rim 23. When sealingly abutting upper rim 23, polymer film 47 is typically heat-sealed to upper rim 23 by the localized application of elevated temperature and pressure to film 47 over rim 23, as is known to the skilled artisan. Alternatively, removable polymer film 47 may indirectly form a seal with upper rim 23, for example, by means of an adhesive 50 (FIG. 7) interposed between polymer film 47 and upper rim 23, as will be discussed in further detail herein.

The surface 24 of upper rim 23 of bowl 11 may have various forms or shapes. For example, surface 24 of upper rim 23 may be a substantially flat surface (as depicted), a convex surface, a concave surface, an irregular surface (having raised and/or recessed features) or any combination thereof. If an adhesive, for example, is interposed between removable polymer film 47 and upper rim 23, surface 24 thereof may be convex, thus providing an annular recessed area in which the adhesive may be contained (not shown). Typically, surface 24 of upper rim 23 is a substantially flat surface.

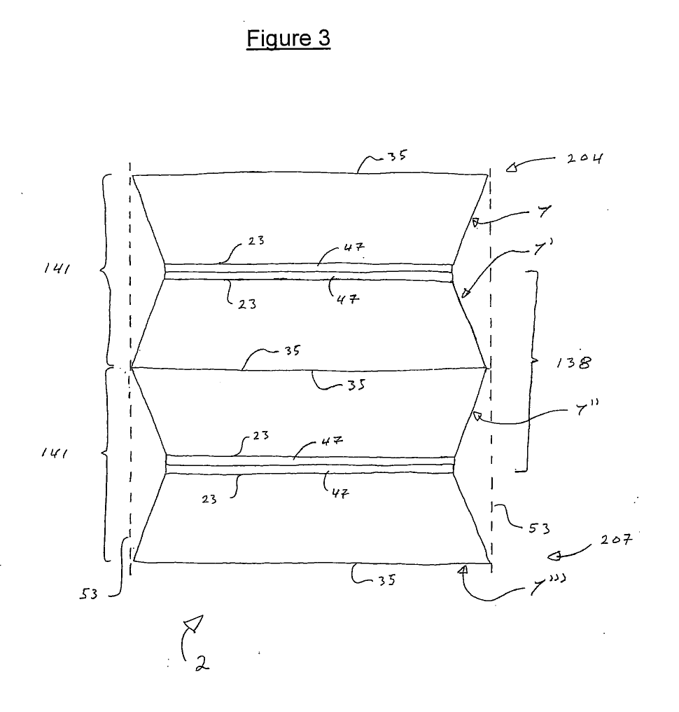

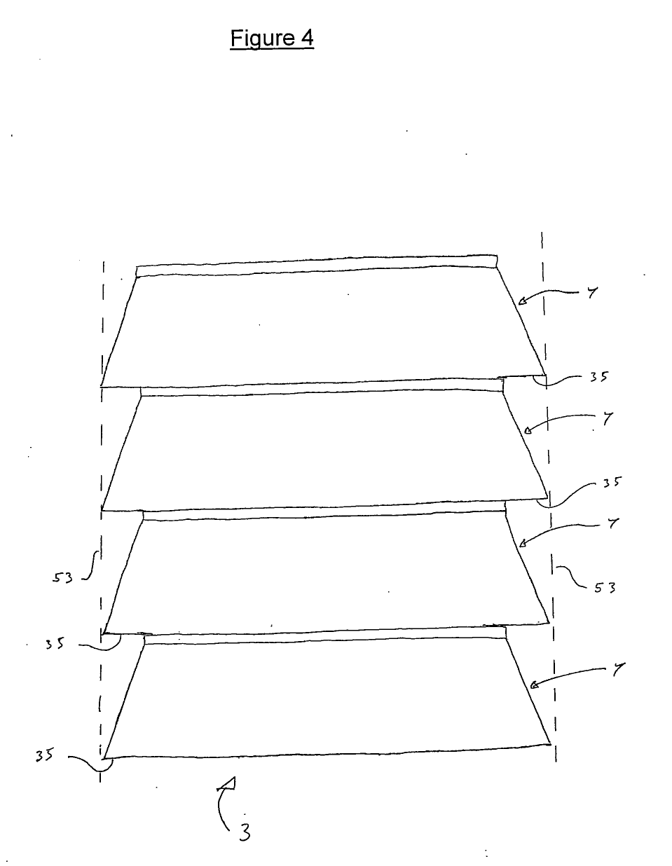

The plurality of containers of the food container assembly of the present invention are arranged in a vertical stack having an outer edge. With reference to FIG. 3, four containers 1 are arranged in a top-to-top and bottom-to-bottom configuration in a vertical stack 2 having an outer edge 53. With reference to FIG. 4, four containers 1 are arranged top-to-bottom (equivalently, bottom-to-top) in a vertical stack 3 having an outer edge 53.

The vertical stack includes at least two containers, and as many containers as may be reasonably packaged and distributed. Typically, the vertical stack includes less than or equal to 20 containers, or less than or equal to 15 containers, or less than or equal to 10 containers, or less than or equal to 7 containers, or less than or equal to 5 containers. The number of containers in a vertical stack may range between any combination of these upper and lower values, inclusive of the recited values. For example, the vertical stack may include 2 to 20, or 2 to 15, or 2 to 10, or 2 to 7, or 2 to 5 containers. As depicted in FIGS. 3 and 4 vertical stacks 2 and 3 each include 4 separate containers.

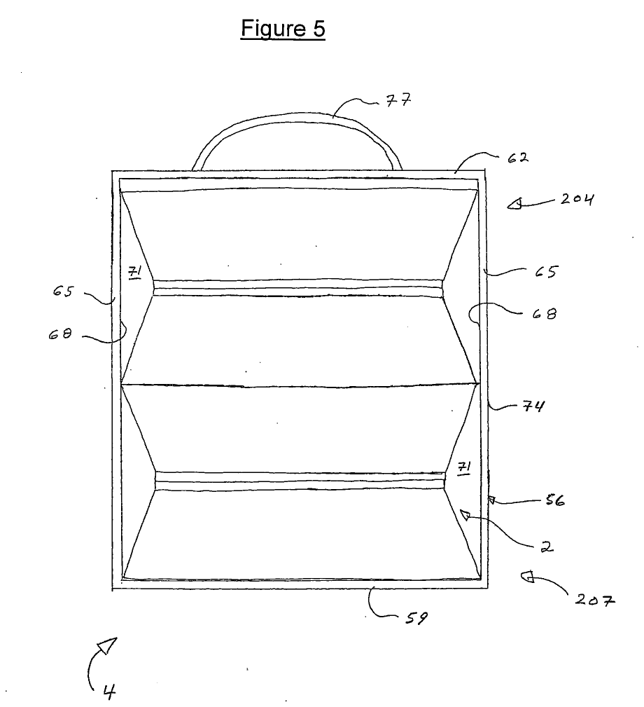

With reference to FIG. 5, the food container assembly 4 of the present invention further includes a tubular receptacle 56 that has a closed bottom 59, a closed top 62, and a continuous sidewall 65. Sidewall 65 has an interior surface 68, which defines an interior space 71 within tubular receptacle 56. Sidewall 65 may be a one-piece sidewall, as is the case, for example, when sidewall 65 is a cylindrical sidewall defining a continuous cylindrical tubular receptacle. Alternatively, sidewall 65 may comprise a plurality of sidewalls, as is the case, for example, when sidewall 65 defines a continuous rectatubular receptacle. Vertical stack 2 resides within interior space 71 of tubular receptacle 56. At least a portion of outer edge 53 (FIG. 3) of vertical stack 2 abuts a portion of inner surface 68 of sidewall 65 of tubular receptacle 56 (FIG. 5). In an embodiment of the present invention, outer edge 53 of vertical stack (e.g., vertical stack 2) slidingly abuts a portion of inner surface 68 of sidewall 65 of tubular receptacle 56 (FIGS. 3 and 5).

Tubular receptacle 56 is a substantially continuous structure, and as such interior space 71 thereof is a substantially sealed interior space. Tubular receptacle 56 is resistant to oxygen (i.e., molecular oxygen) permeation therethrough. In particular, tubular receptacle 56 is resistant to molecular oxygen, from an exterior atmosphere, permeating or passing through tubular receptacle 56 into interior space 71. As such, tubular receptacle 56 has oxygen barrier properties. Depending on the material(s) from which tubular receptacle 56 is fabricated, the oxygen barrier properties thereof may be due to tubular receptacle 56 acting as a physical barrier to oxygen and/or as an oxygen scavenger.

As used herein and in the claims, the term “oxygen permeability values” and similar terms refers to such values that are determined in accordance with ASTM D3985-05, using a suitable testing apparatus having a coulometric sensor, such as a MOCON OX-TRAN 2/20 tester, under conditions of 23° C., 100 percent oxygen, and zero (0) percent relative humidity.

The upper limit of the oxygen permeability value of the tubular receptacle of the food container assembly of the present invention is typically less than or equal to 15 (cm³/m²/day), more typically less than or equal to 10 (cm³/m²/day), in particular less than or equal to 5 (cm³/m²/day), and more particularly less than or equal to 1 (cm³/m²/day). The lower limit of the oxygen permeability values is typically greater than 0, as some small amount of molecular oxygen usually permeates through the tubular receptacle into the interior space thereof. The lower limit of the oxygen permeability values of the tubular receptacle is typically greater than or equal to 0 (cm³/m²/day), more typically greater than or equal to 0.1 (cm³/m²/day), or in particular greater than or equal to 0.2 (cm³/m²/day). The oxygen permeability value of the tubular receptacle may range between any combination of these upper and lower values, including the recited values. For example, the oxygen permeability value of the tubular receptacle may range from 0 to 15 (cm³/m²/day), 0.1 to 10 (cm³/m²/day), 0.1 or 0.2 to 5 (cm³/m²/day), or 0.1 or 0.2 to 1 (cm³/m²/day).

The tubular receptacle typically includes at least one layer having oxygen barrier properties. The oxygen barrier layer may comprise polymers having oxygen barrier properties, for example: ethylene vinyl alcohol copolymers (EVOH), e.g., containing from 26 to 48 mole percent of ethylene and from 52 to 74 mole percent of vinyl alcohol, based on total mole percent; vinyl alcohol polymers, e.g., polyvinylalcohol polymers (PVOH); polyamides (e.g., polyamide-6, polyamide 6-6, amorphous polyamides containing isophthalate and/or terephthalate residues, and combinations thereof); vinylidene chloride polymers (e.g., vinylidene chloride/vinyl chloride copolymers, and vinylidene chloride/methyl acrylate copolymers); and combinations thereof. Examples of amorphous polyamides that may be used in the tubular receptacle of the present invention include, SELAR PA amorphous polyamides, commercially available from E.I. du Pont de Nemours and Company, and GRIVORY amorphous polyamides, commercially available from EMS-Chemie Holding AG.

The tubular receptacle is typically fabricated from a multilayer film that includes at least one internal (or core) oxygen barrier layer (e.g., comprising EVOH) that is interposed between at least two other polymer layers, such as protective polymer layers. Protective polymer layers typically provide the multilayer film with desirable properties, such as abrasion resistance, flex-cracking resistance, moisture resistance, improved melt strength during coextrusion processing, and combinations thereof. The multilayer film may be prepared by known methods, such as coextrusion methods, blown film coextrusion methods, and/or film casting methods. Protective polymer layers may include, for example: polyolefins, such as polyethylene (e.g., high density polyethylene) and/or polypropylene; polyesters, such as polyethyleneterephthalate; silicone polymers (e.g., formed from silane solutions); and combinations thereof. Some polymeric materials may serve more than one purpose, and as such may be present in different layers of the multilayer film. For example, polyamides, such as polyamide 6-6, while having oxygen barrier properties, are sufficiently tough (e.g., providing abrasion resistance and/or flex-cracking resistance) to serve as an exterior film layer that may have indicia applied thereto.

As used herein and in the claims, the term “polyolefin” and similar terms, such as “polyalkylene” and “thermoplastic polyolefin”, for example as used with regard to the tubular receptacle, the bowl, the sleeve and the removable polymer film, means polyolefin homopolymers, polyolefin copolymers, homogeneous polyolefins and/or heterogeneous polyolefins. For purposes of illustration, examples of a polyolefin copolymers include those prepared from ethylene and one or more C₃-C₁₂ alpha-olefins, such as 1-butene, 1-hexene and/or 1-octene.

The polyolefins used in, for example the tubular receptacle, the bowl, the sleeve and the removable polymer film may be heterogeneous polyolefins, homogeneous polyolefins, or combinations thereof. The term “heterogeneous polyolefin” and similar terms means polyolefins having a relatively wide variation in: (i) molecular weight amongst individual polymer chains (i.e., a polydispersity index of greater than or equal to 3); and (ii) monomer residue distribution (in the case of copolymers) amongst individual polymer chains. The term “polydispersity index” (PDI) means the ratio of M_{w}/Mₙ, where M_{w} means weight average molecular weight, and Mₙ means number average molecular weight, each being determined by means of gel permeation chromatography (GPC) using polyethylene standards. Heterogeneous polyolefins are typically prepared by means of Ziegler-Natta type catalysis in heterogeneous phase.

The term “homogeneous polyolefin” and similar terms means polyolefins having a relatively narrow variation in: (i) molecular weight amongst individual polymer chains. (i.e., a polydispersity index of less than 3); and (ii) monomer residue distribution (in the case of copolymers) amongst individual polymer chains. As such, in contrast to heterogeneous polyolefins, homogeneous polyolefins have similar chain lengths amongst individual polymer chains, a relatively even distribution of monomer residues along polymer chain backbones, and a relatively similar distribution of monomer residues amongst individual polymer chain backbones. Homogeneous polyolefins are typically prepared by means of single-site, metallocene or constrained-geometry catalysis. The monomer residue distribution of homogeneous polyolefin copolymers may be characterized by composition distribution breadth index (CDBI) values, which are defined as the weight percent of polymer molecules having a comonomer residue content within 50 percent of the median total molar comonomer content. As such, a polyolefin homopolymer has a CDBI value of 100 percent. For example, homogenous polyethylene/alpha-olefin copolymers typically have CDBI values of greater than 60 percent or greater than 70 percent. Composition distribution breadth index values may be determined by art recognized methods, for example, temperature rising elution fractionation (TREF), as described by Wild et al, Journal of Polymer Science, Poly. Phys. Ed., Vol. 20, p. 441 (1982), or U.S. Pat. No. 4,798,081, or U.S. Pat. No. 5,089,321. An example of homogeneous ethylene/alpha-olefin copolymers are SURPASS polyethylenes, commercially available from Nova Chemicals Inc.

The multilayer film may include one or more adhesive or tie layers. An adhesive layer is typically interposed between two polymeric layers so as to improve adhesion there-between. The adhesive layer may include, for example: anhydride modified polyolefins, such as polyethylene maleic anhydride copolymers; linear low density polyolefins, such as linear low density polyethylene (LLDPE); and combinations thereof.

An outer-most (or external) sealant layer may be included in the multilayer film of the tubular receptacle in an embodiment of the present invention. If present, the outer-most sealant layer typically defines the interior surface 68 of tubular receptacle 56. The outer-most sealant layer may be present for purposes of fabricating the tubular receptacle from separate coextruded multilayer films. For example, top 62, sidewall 65 and bottom 59 may each be separately coextruded multilayer films, having the same or different layer compositions, and each having an outer-most sealant layer. Tubular receptacle 56 may then be formed by a heat sealing process involving, positioning the separate coextruded multilayer films so as to abut portions of their respective outer-most sealant layers, and applying elevated temperature and pressure to the abutting portions, as is known to the skilled artisan. The sealant layer may include linear low density polyolefins, such as linear low density polyethylene.

In an embodiment of the present invention, tubular receptacle 56 is formed by: separately coextruding top 62, sidewall 65 and bottom 59, each having an outer-most sealant layer; heat sealing sidewall 65 and closed bottom 59 together in the manner described above; placing the vertical stack 2 of food containers 1 into the interior space defined by sidewall 65 and closed bottom 59; and then heat sealing together top 62 and the upper portion of sidewall 65, thereby forming food container assembly 4.

The tubular receptacle may be fabricated by other art recognized methods, such as blow molding. For example, the tubular receptacle may be formed by: coextruding a single multilayer parison; introducing the parison into a blow mold at a temperature above the softening point of the parison; pressurizing the interior of the parison such that the parison conforms to the interior surface of the blow mold; allowing the expanded parison to cool; and removing the tubular receptacle from the blow mold.

Optionally, the multilayer film may further include one or more metallic layers (e.g., metal foil layers). The metallic layer may be introduced into the multilayer film by lamination of a pre-formed metal foil. Alternatively, the metal layer may be introduced into the multilayer film by means of sputtering metal onto the surface of a polymeric layer, in accordance with art-recognized methods. If present, the metallic layer does not typically define an exterior surface of the multilayer film, but rather is interposed between at least two polymeric layers primarily for purposes of protecting the metallic layer from damage.

The multilayer film of the tubular receptacle may include one or more polymer layers having oxygen scavenger properties. While not meaning to be bound by theory, it is believed, based on the evidence at hand, that oxygen scavengers react with oxygen that passes or permeates into the film. The oxygen scavenger is typically oxidized in the presence of molecular oxygen. A film layer having oxygen scavenger properties typically includes: (i) a polymer, such as polyolefins, polyvinylchlorides, polyurethanes, polyamides, ethylene vinyl acetate, polyvinylalcohol polymers, ethylene vinyl alcohol copolymers and combinations thereof; (ii) an oxygen scavenger; and optionally (iii) a catalyst, such as a transition metal catalyst (e.g., cobalt ll), typically accompanied by a counterion (e.g., 2-ethylhexanoate or neodecanoate). Examples of oxygen scavengers include, but are not limited to, unsaturated hydrocarbons, ascorbic acid derivatives, sulfites, bisulfites, phenolics, and polymers containing unsaturated groups, such as oxidizable polydienes.

The tubular receptacle preferably also has moisture barrier properties. As used herein and in the claims, the term “moisture permeability values” and similar terms, refers to such values that are determined in accordance with ASTM F1249-05, using a suitable testing apparatus, such as a MOCON PERMATRAN-W tester, under conditions of 37.8° C. and 100 percent relative humidity. Typically, the upper limit of the moisture permeability value of the tubular receptacle is less than or equal to 5 (g/m²/day), more typically less than or equal to 1 (g/m²/day), and in particular less than or equal to 0.05 (g/m²/day). The lower limit of the moisture permeability value of the tubular receptacle is preferably 0 (g/m²/day). The lower limit, however, of the moisture permeability value is typically greater than zero, as some water (e.g., molecular water) usually permeates through the tubular receptacle into the interior space thereof. The lower limit of the moisture permeability value of the tubular receptacle is typically greater than or equal to 0.01 (g/m²/day), more typically greater than or equal to 0.02 (g/m²/day), and in particular greater than or equal to 0.03 (g/m²/day). The moisture permeability value of the tubular receptacle may range between any combination of these upper and lower limits, inclusive of the recited values. For example, the moisture permeability value of the tubular receptacle may range from 0 or 0.01 to 5 (g/m²/day), 0.02 to 1 (g/m²/day), or 0.03 to 0.05 (g/m²/day). Moisture barrier properties may be provided by polymer layers comprising polyolefins, such as polyethylene homopolymers, ethylene/alpha-olefin copolymers, polypropylenes and combinations thereof.

The tubular receptacle may also have oil resistant properties. Oil resistant properties may be provided by low density polyethylene/alpha-olefin copolymers.

In an embodiment of the present invention, the tubular receptacle is a multilayer film that includes at least one layer having oxygen barrier properties, having, for example, the following representative general structure,

A|B|C|B|D

Layer A is an external protective layer that includes, for example, polyamide (e.g., polyamide 6-6), and may optionally have indicia applied to a surface thereof. Layers B are each adhesive/tie layers, and include, for example, anhydride modified polyolefins, such as polyethylene maleic anhydride copolymers. Layer C is an oxygen barrier layer comprising, for example, ethylene vinyl alcohol copolymers. Layer D is a sealant layer comprising, for example, linear low density polyethylene.

The tubular receptacle may include indicia applied to an exterior surface thereof or an exterior surface of an outer-most layer of a multilayer film thereof (e.g., internal surface 68 and/or external surface 74 of sidewall 65). Alternatively, indicia may be applied to the interior surface of an outer-most layer of a multilayer film of the tubular receptacle, in which case the indicia is interposed between an outer-most layer and an underlying layer. Further alternatively, an internal layer of the multilayer film of the tubular receptacle may have indicia applied thereto. Indicia may be applied by art recognized methods, such as laser printing, ink-jet printing and screen printing. The indicia may be applied prior to or after lamination of the plurality of layers that form the multilayer film. If interposed between two layers, the indicia is typically applied to a surface of a film layer prior to lamination thereof with another film layer. Examples of indicia include, but are not limited to, letters, numbers, symbols, designs and bar codes, such as one dimensional and two dimensional bar codes. The indicia may be of any color or combination of colors.

In an embodiment of the present invention, the tubular receptacle includes a label having indicia thereon. The label may be applied to an outer-most surface (e.g., internal surface 68 and/or external surface 74 of sidewall 65) of the tubular receptacle by means of an adhesive. Alternatively, the label may be interposed between two layers of the multilayer film of the tubular receptacle during coextrusion, in accordance with art-recognized methods. Further alternatively, if the tubular receptacle is prepared by a molding method, such as blow molding or vacuum molding, the label may be fixed thereto by in-mold labeling. With in-mold labeling, a label, which is in contact with an internal surface of the mold, becomes bonded to, fused with or embedded in the plastic material contacted therewith (e.g., the parison in the case of blow molding) during the molding operation, as is known to the skilled artisan. The label may have indicia applied to one or both opposing surfaces thereof. The label may be a multilayered label, in which case the indicia of the label may optionally be interposed between two or more layers thereof.

The tubular receptacle may be opaque, for example, when fabricated from a multilayer film that includes a metallic layer. In an embodiment of the present invention, at least a portion of the tubular receptacle is transparent and allows for visual inspection of the vertical stack contained therein. In particular, a transparent tubular receptacle will typically have a transparency value of greater than or equal to 50 percent, as determined in accordance with ASTM D1003-00. Accordingly, when transparent, the tubular receptacle will also typically have a haze value of less than or equal to 15 percent, as determined in accordance with ASTM D1003-00. Haze values indicate the percentage of transmitted light that is scattered forward while passing through a test sample.

The thickness of the film from which the tubular receptacle is fabricated may vary widely. Typically, the single layer or multilayer film from which the tubular receptacle is fabricated (and, accordingly, the tubular receptacle itself) has a thickness of from 50 microns to 762 microns (2 mils to 30 mils), more typically from 76 microns to 508 microns (3 mils to 20 mils), and in particular from 127 microns to 381 microns (5 mils to 15 mils), inclusive of the recited values. In addition, top 62, sidewall 65 and base 59 of tubular receptacle 56 may each independently have a thickness selected from any of these recited ranges. The tubular receptacle may be rigid or flexible. If rigid, the tubular receptacle is substantially self supporting. If flexible, the tubular receptacle is not self supporting, and accordingly collapses upon itself by action of gravity, for example in the absence of a vertical stack of food containers within the interior space thereof.

In an embodiment of the present invention, tubular receptacle 56 is substantially rigid, and base 59 is dimensioned to support tubular receptacle 56 in an upright position. To provide such support, base 59 is typically substantially horizontal or flat. In addition, base 59 may have a thickness that is greater than that of sidewall 65 and/or top 62. For example, base 59 may have a thickness of 508 microns to 762 microns (20 mils to 30 mils), while sidewall 65 and top 62 each independently have a thickness of from 127 microns to 381 microns (5 mils to 15 mils). In addition, base 59 typically has a surface area that is equal to or greater than that of top 62. For example, when top 62 and base 59 each have a circular shape, base 59 typically has a radius that is equal to or greater than the radius of top 62.

The tubular receptacle of the food container assembly may have a wide variety of cross sectional shapes, provided that the vertical stack of food containers may be received within the interior space thereof. For example, tubular receptacle may have a cross sectional shape selected from circles, ovals (e.g., ellipses), polygons (e.g., triangles, rectangles, squares, pentagons, hexagons, etc), irregular shapes (e.g., combinations of circular and polygonal shapes) and combinations thereof. In an embodiment of the present invention, tubular receptacle 56 has a substantially circular cross section, and accordingly top 62 and bottom 59 each have circular shapes, and tubular receptacle 56 is a substantially cylindrical receptacle. In another embodiment of the present invention, tubular receptacle 56 has a rectangular cross section, and accordingly top 62 and bottom 59 each have rectangular shapes, and tubular receptacle 56 is a rectatubular receptacle.

The food container assembly of the present invention may include at least one handle 77 fixedly attached to the tubular receptacle 56 (FIG. 5). The handle may be fixedly attached to any portion or combination of portions of the tubular receptacle. For example, one or more handles, such as handle 77, may be fixedly attached to top 62 (as depicted), sidewall 65, bottom 59, or combinations thereof (not shown). The handle may be fabricated from any suitable material, for example, wood, hemp, fabric, thermoset plastic materials, thermoplastic materials, and combinations thereof. Typically, the handle is fabricated from a thermoplastic material (e.g., polyethylene) and is fixedly attached to tubular receptacle 56 by means of adhesives or heat-sealing, in accordance with art-recognized methods, as described previously herein.

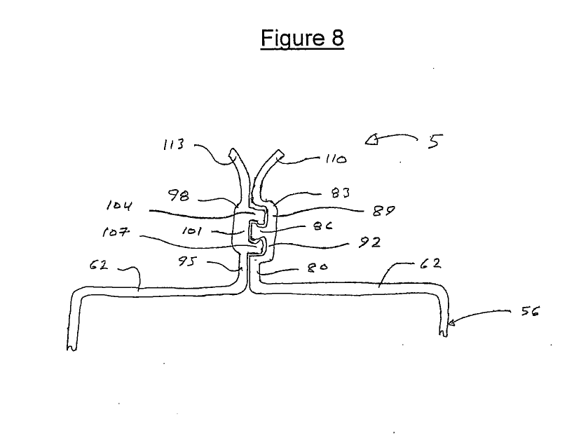

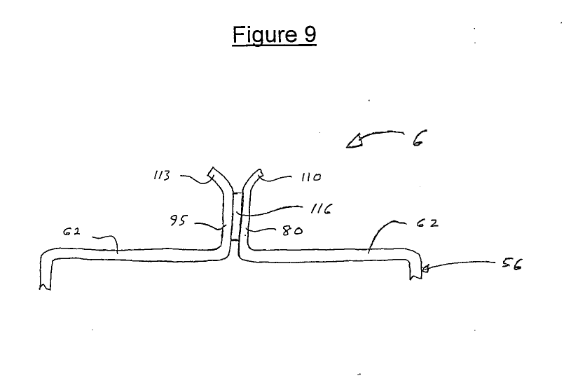

One or more reversibly sealable openings may be included in the tubular receptacle of the food container assembly of the present invention. The reversibly sealable opening may be located in any portion or combination of portions of the tubular receptacle. The reversibly sealable opening may be selected from those known to the skilled artisan, such as tongue-in-groove type (FIG. 8) and adhesive type (FIG. 9) reversibly sealable openings.

With reference to FIG. 8, top 62 of tubular receptacle 56 includes a reversibly sealable tongue-in-groove opening 5. Reversibly sealable tongue-in-groove opening 5 includes a first opposite side 80 that includes a first set of interlocking (or coupling) structures 83 comprising an extension 86 positioned between two recesses 89 and 92. Tongue-in-groove opening 5 also includes a second opposite side 95 that includes a second set of interlocking structures 98 that includes a recess 101 positioned between two extensions 104 and 107. Reversibly sealable tongue-in-groove opening 5 may be sealed by a person pressing opposite sides 80 and 95 between their thumb and index finger, and sliding their pressed thumb and index finger longitudinally along reversible opening 5. In so doing, interlocking structures 83 and 98 become cooperating interlocking structures which seal opposite sides 80 and 95 together. In particular, extension 86 of interlocking structure 83 cooperates interlockingly and sealingly with recess 101 of interlocking structure 98, and extensions 104 and 107 of interlocking structure 98 cooperate interlockingly and sealingly with recesses 89 and 92 of interlocking structure 83, thereby sealing opposite sides 80 and 95 of top 62 together. Reversible tongue-in-groove opening 5 may be fitted with a slider (not shown) that serves to close and open the opening by longitudinal movement thereof (rather than by squeezing opening 5 slidingly between a thumb and index finger), as is known to the skilled artisan. Reversibly sealable tongue-in-groove opening 5 may be reversibly opened by gripping and pulling apart flap 110 of first opposite side 80, and flap 113 of second opposite side 95. Further tongue-in-groove type reversibly sealable openings are known in the art, and include, for example, those described in U.S. Pat. Nos. 2,810,944 and 5,138,750.

With reference to FIG. 9, top 62 of tubular receptacle 56 includes a reversibly sealable adhesive type opening 6. Reversibly sealable adhesive type opening 6 includes first upwardly extending opposite side 80 and a second upwardly extending opposite side 95, each having an adhesive material 116 interposed there-between. Reversibly sealable adhesive type opening 6 may be sealed by a person pressing opposite sides 80 and 95 between their thumb and index finger, and sliding their pressed thumb and index finger longitudinally along reversible opening 6. In so doing, adhesive 116 sealingly abuts the inner surfaces of opposite sides 80 and 95, thereby sealing opening 6 of receptacle 56. Reversibly sealable adhesive type opening 6 may be fitted with a slider (not shown) that serves to close and open the opening by longitudinal movement thereof (rather than by squeezing opening 6 slidingly between a thumb and index finger), as is known to the skilled artisan. Reversibly sealable adhesive opening 6 may be opened by gripping and pulling apart flap 110 of first opposite side 80, and flap 113 of second opposite side 95. Adhesive material 116 may be selected from art-recognized adhesive materials that do not form a permanent bond between opposing structures, such as opposite sides 80 and 95 of top 62. For example, adhesive material 116 may be selected from thermoplastic polyurethane adhesives and thermoplastic polyolefin adhesives, such as linear low density polyethylene adhesives.

As discussed previously herein, each container includes a sleeve that extends downwardly from the upper rim of the bowl. With further reference to FIG. 1, sleeve 29 forms an exterior angle 119 below a horizontal relative to upper rim 23, as depicted by representative horizontal dashed line 121. Sleeve 29 may extend downwardly and outwardly from rim 23 (as depicted in FIG. 1), in which case exterior angle 119 is greater than 0° and less than 90° (e.g., 45° relative to line 121) and accordingly lower edge 35 extends laterally outward beyond outer portion 132 (FIG. 2) of upper rim 23, thereby defining an outer lateral edge 135 of container 1. Alternatively, sleeve 29 may extend straight down from upper rim 23, in which case angle 119 is equal to 90° (not shown). Further alternatively, sleeve 29, may extend downwardly and inwardly from upper rim 23, in which case angle 119 is greater than 90° and less than 180°, e.g., 120° (not shown). Typically, sleeve 29 extends downwardly and outwardly from upper rim 23, and exterior angle 119 is greater than 0° and less than 90°.

As discussed previously herein, the vertical stack of food containers (e.g., vertical stack 2 of FIG. 3, and vertical stack 3 of FIG. 4) has an outer edge 53, which is defined by the vertically aligned outer lateral edge 135 of each container 1. Depending on the angle 119 formed by sleeve 29 extending downwardly from upper rim 23, outer lateral edge 135 of each container (and correspondingly outer edge 53 of the vertical stack of containers) may be defined by lower edge 35 of sleeve 29, outer portion 132 of upper rim 23 or a combination thereof. In particular, when sleeve 29 extends downwardly and outwardly from upper rim 23, angle 119 is greater than 0° and less than 90°, and accordingly outer lateral edge 135 is defined by lower edge 35 of sleeve 29 of container 1, which correspondingly serves to define outer edge 53 of the vertical stack (FIGS. 3 and 4). When sleeve 29 extends straight down from rim 23, angle 119 is equal to 90°, and accordingly outer lateral edge 135 is defined by both outer portion 132 of upper rim 23 and lower edge 35 of sleeve 29, which correspondingly together serve to define outer edge 53 of the vertical stack (not shown). When sleeve 29 extends downwardly and inwardly from rim 23, angle 119 is greater than 90° and less than 180°, and accordingly outer lateral edge 135 is defined by outer portion 132 of upper rim 23, which correspondingly serves to define outer edge 53 of the vertical stack (not shown).

Bowl 11 and sleeve 29 may be continuous one with the other, in which case container 1 is a substantially solid container, aside from bowl interior 20. In an embodiment of the present invention, sleeve 29 has an inner surface 124, and bowl 11 has an outer surface 126, which together define an annular space 129 there-between. In addition, sleeve 29 extends downwardly and outwardly from upper rim 23, such that lower edge 35 of sleeve 29 defines outer lateral edge 135 of container 1. Outer lateral edge 135 of each container 1 of the vertical stack of containers (e.g., 2 or 3) is substantially vertically aligned and together define outer edge 53 of the vertical stack.

In an embodiment of the present invention, open top 26 (and correspondingly upper rim 23) of bowl 11 is substantially circular, sleeve 29 is a conical sleeve having a circular lower edge 35, and accordingly annular space 129 is a substantially conical annular space 129.

The containers of the vertical stack of the food container assembly of the present invention may be arranged in a top-to-bottom (equivalently a bottom-to-top) configuration, a top-to-top configuration, a bottom-to-bottom configuration, or combinations thereof. In an embodiment of the present invention, the containers of the vertical stack are arranged so as to have a top-to-top and/or a bottom-to-bottom configuration. More particularly and with reference to FIG. 3, vertical stack 2 may include: (i) a first pair of neighboring containers 138 in which lower edge 35 of each of the first pair of neighboring containers 138 are substantially aligned and abut each other (i.e., first pair of neighboring containers 138 being arranged in a bottom-to-bottom configuration); and/or (ii) a second pair of neighboring containers 141 in which each upper rim 23 of the second pair of neighboring containers 141 are substantially aligned, and the removable polymer film 47 of each of the second pair of neighboring containers 141 are adjacent to each other (e.g., abut each other).

Depending on the material(s) from which removable polymer film 47 is prepared (as will be discussed in further detail herein), the removable polymer films 47 of the second pair of neighboring containers 141 (e.g., arranged in a top-to-top configuration) may become fused together during storage (e.g., storage at elevated temperatures, such as greater than or equal to 35° C.). Fusing of the removable polymer films together is typically referred to as blocking of the films together. Blocking may occur when the abutting removable polymer films are fabricated from polymeric materials: having low glass transition temperatures (Tg); and/or having low melting points; and/or comprising migratory plasticizers that migrate between the abutting films.

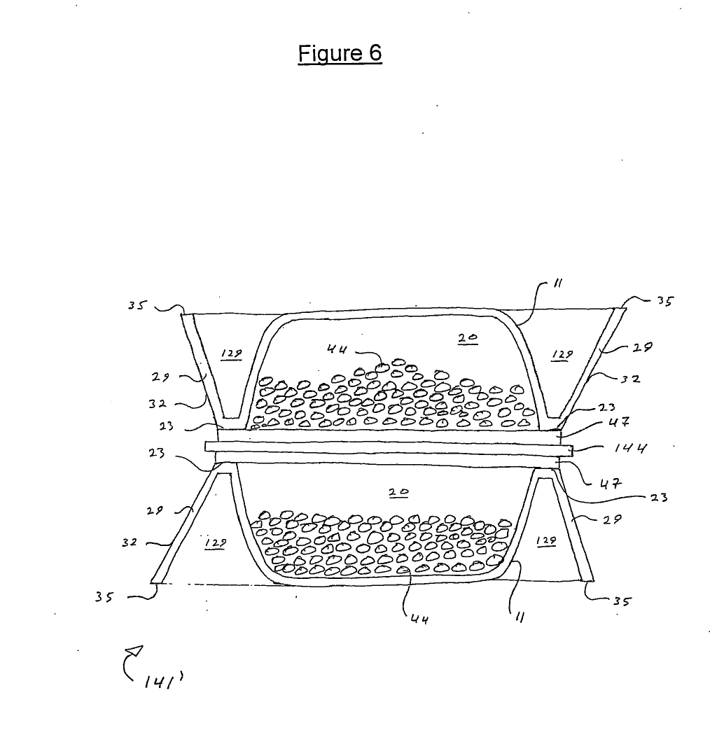

With reference to FIG. 6, to at least minimize and preferably eliminate blocking between removable polymer films 47, a blocking resistant film 144 is interposed between each second pair of neighboring containers 141′. Blocking resistant film 144 is positioned such that the removable polymer film 47 of each second pair of neighboring containers 141′ abuts blocking resistant film 144. Blocking resistant film 144 may be fabricated from any suitable material that serves to inhibit or eliminate blocking between removable polymer films 47. For example, blocking resistant film 144 may be fabricated from paper, metal (e.g., metal foil), fabrics (e.g., cotton cloth), thermoset polymer materials, thermoplastic polymers and combinations thereof. When fabricated from thermoplastic materials, blocking resistant film 144 typically has a Tg that is greater than that of removable polymer films 47 (e.g., a Tg of greater than or equal to 30° C. or 150° C.).

The removable polymer film of the container may be fabricated from a single layer polymer film or a multilayered polymer film. Typically, the removable polymer film is fabricated from a thermoplastic material having heat sealing properties. This allows removable polymer film 47 to be heat sealed to upper rim 23 of bowl 11 by the application of elevated temperature and pressure in accordance with art recognized methods. Examples of thermoplastic polymers having heat sealing properties from which the removable polymer film, or a heat sealing layer(s) thereof, may be prepared, include but are not limited to: polyethylene homopolymers; linear low density polyethylene; polyethylene copolymers prepared from ethylene and at least one C₃-C₁₂ alpha-olefin, such as 1-butene, 1-hexene and/or 1-octene; copolymers of ethylene and styrene; ethylene vinyl acetate (EVA) copolymers; ethylene methacrylate (EMA) copolymers; ethylene acrylic acid copolymers; ethylene methacrylic acid copolymers; copolymers of hexene and butene; polybutylene; ionomers; acid anhydride modified ethylene vinyl acetate copolymers; and combinations (e.g., blends) thereof.

Ionomers having heat sealing properties, from which the removable polymer film, or a heat sealing layer(s) thereof may be prepared, are typically copolymers prepared from one or more alpha-olefin monomers (e.g., at least one C₂-C₁₂ alpha-olefin, such as ethylene) and relatively small amounts (e.g., 1 to 10 percent) of an unsaturated carboxylic acid monomer (e.g., methacrylic acid), which are treated with a metal salt, such as zinc acetate. A non-limiting example of a commercially available class of ionomers that may be used in the present invention are SURLYN packaging resins, commercially available from E.I. du Pont de Nemours and Company.

In addition, the removable polymer film, or a heat sealing layer(s) thereof, may be prepared from a blend (e.g., an immiscible blend) of thermoplastic polymers comprising: (a) a first polymer, forming a substantially continuous phase, selected from polyethylene homopolymers; polyethylene copolymers prepared from ethylene and at least one C₃-C₁₂ alpha-olefin, such as 1-butene, 1-hexene and/or 1-octene; copolymers of ethylene and styrene; ethylene vinyl acetate (EVA) copolymers; ethylene methacrylate (EMA) copolymers; ethylene acrylic acid copolymers; ethylene methacrylic acid copolymers; copolymers of hexene and butene; polybutylene; ionomers; acid anhydride modified ethylene vinyl acetate copolymers; and combinations (e.g., blends) thereof; and (b) a second polymer, forming a substantially discontinuous phase, selected from polybutylene; polypropylene homopolymers; polypropylene copolymers prepared from propylene and at least one C₂-C₁₂ alpha-olefin exclusive of propylene (e.g., C₂ and/or C₄-C₁₂ alpha-olefin), such as ethylene, 1-butene, 1-hexene and/or 1-octene; high density polyethylene; crosslinked polyethylene; and combinations (e.g., blends) thereof; provided the first polymer (a) and the second polymer (b) are different polymers. The first polymer of the heat sealable blend is typically present in an amount of from 5 to 95 percent by weight, more typically from 50 to 90 percent by weight, and further typically from 60 to 80 percent by weight, based on the total weight of the blend. The second polymer of the heat sealable blend is typically present in an amount of from 5 to 95 percent by weight, more typically from 10 to 50 percent by weight, and further typically from 20 to 40 percent by weight, based on the total weight of the blend.

To prevent damage (e.g., discoloration and/or burn-through) to the removable polymer film during heat sealing operations, a multilayered film having at least two layers is typically used. The multilayered film typically comprises a heat sealable layer that abuts upper rim 23, and at least one heat seal resistant layer superposed thereover. As used herein and in the claims and with regard to the removable polymer film, the term “heat seal resistant layer” and similar terms means a polymer layer that is substantially not heat sealable under the same conditions that the heat sealable layer is sealed (the heat seal resistant layer typically having a melting point greater than that of the heat sealable layer). For example, a heat seal resistant layer will typically be substantially free of heat sealing properties relative to upper rim 23 (e.g., having a peel strength of less than 1 N, for example 0 N, as determined in accordance with ASTM F88-06) when subjected to a sealing temperature of 100° C. to 130° C. and a sealing pressure of 40 psi (2.8 kg/cm²), for a period of 0.5 seconds. As used herein and in the claims and with regard to the removable polymer film, the term “heat sealable layer” and similar terms means a polymer layer that is heat sealable under the same conditions that the heat seal resistant layer is not sealed (the heat sealable layer typically having a melting point less than that of the heat seal resistant layer). For example, a heat sealable layer will typically have heat seal properties relative to upper rim 23 (e.g., having a peel strength of 1 N to 15 N, as determined in accordance with ASTM F88-06) when subjected to a sealing temperature of 100° C. to 130° C. and a sealing pressure of 40 psi (2.8 kg/cm²), for a period of 0.5 seconds.

The heat sealable layer(s) of the multilayer removable polymer film may be fabricated from suitable polymers selected from those examples recited previously herein, for example, linear low density polyethylene, a blend (e.g., an immiscible blend) of polyethylene and polypropylene, or a blend of polyethylene and polybutylene. Examples of polymers from which the heat seal resistant layer(s) of the multilayer removable polymer film may be fabricated include, but are not limited to: high density polyethylene; medium density polyethylene; polypropylene; polyamides (including those recited previously herein with regard to the tubular receptacle); polyesters; polyacrylonitrile; polyvinylidene chloride; and combinations (e.g., blends) thereof. The multilayered film may be prepared by art-recognized methods, such as coextrusion, blown film coextrusion and/or film casting methods, as discussed previously herein with regard to the tubular receptacle.

The removable polymer film of the container is not necessarily resistant to oxygen permeation therethrough, e.g., having an oxygen permeability value in excess of 15 (cm³/m²/day), as determined in accordance with those procedures and conditions as discussed previously herein with regard to the tubular receptacle. In addition, the removable polymer film is not necessarily resistant to moisture permeation therethrough, e.g., having a moisture permeation value of greater than 5 (g/m²/day), as determined in accordance with those procedures and conditions as discussed previously herein with regard to the tubular receptacle.

In an embodiment of the present invention, the removable polymer film is resistant to the permeation of oxygen therethrough, in which case, it is a multilayer film having a heat sealable layer adjacent to or abutting the upper rim of the bowl, and at least one layer having oxygen barrier properties superposed thereover. The layer(s) having oxygen barrier properties may be fabricated from polymers selected from those examples recited previously herein with regard to the tubular receptacle (e.g., ethylene vinyl alcohol copolymers and polyamides). The oxygen permeability values of the removable polymer film may be selected from those values and ranges disclosed previously herein with regard to the tubular receptacle, e.g., 0 to 15 or 0.1 to 10 (cm³/m²/day). The removable polymer film may also have moisture barrier properties, in which case, one or more of the layers superposed over the heat sealable layer have moisture barrier properties, and may be fabricated from polymers selected from those examples recited previously herein with regard to the tubular receptacle which provide moisture barrier properties (e.g., polyethylenes and polypropylenes). The moisture permeability values of the removable polymer film may be selected from those values and ranges disclosed previously herein with regard to the tubular receptacle, e.g., 0 or 0.1 to 5 or 0.02 to 1 (g/m²/day).

The multilayer film from which removable polymer film 47 is fabricated may optionally further include a metallic layer, such as a metal foil layer. The metallic layer may be introduced into the multilayer film of the removable polymer film by art-recognized methods, such as coextrusion and/or metal sputtering methods, as discussed previously herein with regard to the tubular receptacle.

In addition, the removable polymer film may include indicia applied thereto. Indicia may be applied to the exterior outer-most surface and/or the interior outer-most surface (i.e., the surface facing food material 44) by art-recognized methods, as discussed previously herein with regard to the tubular receptacle. Examples of indicia that may be introduced into the removable polymer film include those recited previously herein with regard to the tubular receptacle. As discussed previously herein with regard to the tubular receptacle, indicia may be introduced between layers of the multilayered film from which removable polymer film 47 is fabricated.

The removable polymer film may optionally further include a label. The label may be applied by means of an adhesive to the exterior outer-most surface and/or the interior outer-most surface of the removable polymer film. Alternatively, the label may be interposed between two layers of a multilayered film from which the removable polymer film is fabricated. The label may have indicia applied to an exterior surface thereof, or to an interior layer thereof when the label is itself fabricated from a multilayered film.

The removable polymer film of the food container may be opaque, for example, when fabricated from a multilayer film that includes a metallic layer. In an embodiment of the present invention, the removable polymer film is transparent and allows for visual inspection of the food 44 contained therein. In particular, a transparent removable polymer film will typically have a transparency value of greater than or equal to 50 percent, as determined in accordance with ASTM D1003-00. Accordingly, when transparent, the removable polymer film will also typically have a haze value of less than or equal to 15 percent, as determined in accordance with ASTM D1003-00. Haze values indicate the percentage of transmitted light that is scattered forward while passing through a test sample.

The thickness of the single layer or multilayer film from which the removable polymer film is fabricated may vary widely. Typically, the single layer or multilayer film from which the removable polymer film is fabricated has a thickness of from 50 microns to 762 microns (2 mils to 30 mils), more typically from 76 microns to 508 microns (3 mils to 20 mils), and in particular from 127 microns to 381 microns (5 mils to 15 mils), inclusive of the recited values.

Removable polymer film 47 of food container 1 is removable from upper rim 23 of bowl 11. Typically, removable polymer film 47 is removed from upper rim 23 by hand without the use of additional implements (e.g., pliers, knives and/or razor blades). Removable polymer film 47 typically has a peel strength (relative to being peeled away from upper rim 23) of greater than 0 N (0 gram-force) and less than or equal to 15 N (1530 gram-force), for example, from 1 N to 15 N (102 to 1530 gram-force), or from 5 N to 10 N (510 to 1020 gram-force), as determined in accordance with ASTM F88-06.

In an embodiment of the present invention, at least a portion of removable polymer film 47 extends out beyond outer edge 132 of upper rim 23, thereby forming an extension or tab (not shown), which may be gripped (e.g., by hand, such as between thumb and index finger) and used to pull removable polymer film 47 off of upper rim 23. In a further embodiment, removable polymer film 47 has a first (or exterior) surface 150 and a second (or interior) surface 147. A portion of second surface 147 sealingly abuts upper rim 23, and removable polymer film 47 further includes a tab 153 fixedly attached to first surface 150 thereof. Tab 153 may be gripped (e.g., by hand) and used to pull removable polymer film 47 off of upper rim 23. In FIG. 2, tab 153 may, as depicted, extend laterally outward beyond outer edge 132 of upper rim 23. Tab 153 may, however, be positioned anywhere on first surface 150 of removable polymer film 47. For example, tab 153 may be positioned so as not to extend beyond outer edge 132 of upper rim 23, and a portion of tab 153 only abutting (i.e., not sealed to) first surface 150 of removable film 47 so as to be pulled up from first surface 150, thus allowing removal of film 47 from upper rim 23.

Tab 153 may be fabricated from suitable materials, such as paper, metal, fabric, thermoset polymers, thermoplastic polymers and combinations thereof. Tab 153 may be fabricated from a single layer or multilayered film. In an embodiment, tab 153 is fabricated from a thermoplastic material, such as polyolefin (e.g., polyethylene).

In an embodiment of the present invention, and with reference to FIG. 7, container 1 further includes an adhesive 50 interposed between upper rim 23 of bowl 11 and a portion of the interior surface 147 of removable polymer film 47. Adhesive 50 may be selected from known adhesive materials having release properties that allow removable polymer film 47 to be removed from upper rim 23. Such materials include, for example, polyolefin adhesives (e.g., linear low density polyethylene materials) and polyurethane adhesives. An adhesive may be employed in the present invention when removable polymer film 47 is fabricated from materials that do not have heat sealable properties (e.g., high density polyolefins, such as high density polyethylenes, and/or thermoset polymers).

The bowl and sleeve of the food container of the assembly may be fabricated from suitable materials, such as cardboard, metals, ceramics, plastics and combinations thereof. Bowl 11 and sleeve 29 of container 1 may be separate elements fixedly attached to each other by fasteners (e.g., screws, clamps and/or nuts and bolts) and/or adhesives (not shown). Typically, bowl 11 and sleeve 29 of container 1 are substantially continuous, forming a substantially unitary structure.

Typically bowl 11 and sleeve 29 of container 1 are each independently fabricated from a plastic material. The plastic material may be selected from thermosetting plastic materials and/or thermoplastic materials.

As used herein and in the claims, the term “thermoset plastic material” and similar terms, such as “thermosetting plastic materials” means plastic materials having a three dimensional crosslinked network resulting from the formation of covalent bonds between chemically reactive groups, e.g., active hydrogen groups and free isocyanate groups. Thermoset plastic materials from which the bowl and sleeve of the container may be fabricated include those known to the skilled artisan, e.g., crosslinked polyurethanes, crosslinked polyepoxides and crosslinked polyesters. Container 1 may be fabricated, for example, from crosslinked polyurethanes by the art-recognized process of reaction injection molding. Reaction injection molding typically involves, as is known to the skilled artisan, injecting separately, and preferably simultaneously, into a mold: (i) an active hydrogen functional component (e.g., a polyol and/or polyamine); and (ii) an isocyanate functional component (e.g., a diisocyanate such as toluene diisocyanate, and/or dimers and trimers of a diisocyanate such as toluene diisocyanate). The filled mold may optionally be heated to ensure and/or hasten complete reaction of the injected components. After at least partial reaction of the injected components, the mold is opened and the molded article, e.g., food container 1, is removed.

As used herein and in the claims, the term “thermoplastic material” and similar terms, means a plastic material that has a softening or melting point, and is substantially free of a three dimensional crosslinked network resulting from the formation of covalent bonds between chemically reactive groups, e.g., active hydrogen groups and free isocyanate groups. Examples of thermoplastic materials from which bowl 11 and sleeve 29 of container 1 may be fabricated include, but are not limited to, thermoplastic polyurethane, thermoplastic polyurea, thermoplastic polyimide, thermoplastic polyamide, thermoplastic polyamideimide, thermoplastic polyester, thermoplastic polycarbonate, thermoplastic polysulfone, thermoplastic polyketone, thermoplastic polyolefins, thermoplastic acrylonitrile-butadiene-styrene and combinations thereof. Of the thermoplastic materials from which bowl 11 and sleeve 29 of container 1 may be fabricated, thermoplastic polyolefins are preferred, such as thermoplastic polyethylenes.

Food container 1 may be prepared by known plastic molding methods, including for example, reaction injection molding (in the case of thermoset plastic materials), injection molding (in the case of thermoplastic materials), thermoforming and/or vacuum forming (in the case of thermoplastic materials), and combinations thereof.

Sleeve 29 and bowl 11 of container 1 may be fabricated from the same or different plastic materials (or plastic compositions). For example, container 1 may be prepared by the art-recognized method of co-injection molding, in which two or more plastic materials and/or compositions are injected into different cavities within the same mold. Alternatively, thermoplastic sheet having a non-uniform composition (e.g., having a circular center area and a surrounding annular area formed from different thermoplastic compositions) may be thermoformed or vacuum formed, thereby resulting in the formation of a container in which the bowl and sleeve thereof have different compositions and optionally different properties.

The bowl and/or the sleeve of the food container may each independently be fabricated from a plastic material/composition that includes reinforcing material. Examples of reinforcing materials that may be included in the plastic compositions from which the bowl and/or sleeve are prepared include, but are not limited to glass fibers, glass beads, carbon fibers, metal flakes, polyamide fibers, nanoparticulate clays, talc and mixtures thereof. If used, the reinforcing/reinforcement material, e.g., glass fibers, is typically present in the plastic material (e.g., thermoset plastic material and/or thermoplastic material) of the bowl and/or sleeve in a reinforcing amount, e.g., in an amount of from 5 percent by weight to 60 percent by weight, or 10 percent by weight to 40 percent by weight, based on the total weight of the bowl and/or sleeve respectively.

In an embodiment of the present invention, the plastic material of sleeve 29 comprises a reinforcing material, and the plastic material of bowl 11 is substantially free of reinforcing material. Such a container may be prepared, for example, by providing a mold having a first cavity defining the bowl and a second cavity defining the sleeve of the container. A first thermoplastic composition that is substantially free of reinforcing material is injected into the first cavity, while a second thermoplastic composition comprising reinforcing material is injected into the second cavity. Injection of the first and second thermoplastic compositions may be conducted sequentially or concurrently. After allowing the injected compositions to cool and solidify, the mold is opened and the molded container removed therefrom. A container in which the plastic material of the bowl is substantially free of reinforcing material, and the plastic material of the sleeve includes reinforcing material, may be desirable for reasons of minimizing or eliminating contact of reinforcing material with food contained within bowl interior 20, while at the same time providing a reinforced sleeve to support the bowl. When the container is used to feed a pet, such as a cat or dog, preparing the bowl from plastic material that is substantially free of reinforcing material (e.g., glass fiber) may be desirable for reasons of minimizing irritation of the pet's tongue as the pet consumes food 44 from bowl interior 20 when swiping their tongue over inner surface 17 of bowl 11.

Open top 26 of food container 1 (and correspondingly upper rim 23 which defines open top 26) may have a shape that is suitable for purposes of allowing the amount of food 44 to be either removed from or consumed directly from within bowl interior 20. Typically, food 44 is consumed directly from within bowl interior 20. Open top 26 (and correspondingly upper rim 23) of bowl 11 may have a shape selected from circles, ovals (e.g., ellipsoid shapes), polygons (e.g., triangles, rectangles, pentagons, hexagons, heptagons, octagons, etc), irregular shapes (e.g., combinations of oval and polygonal shapes) and combinations thereof. Lower edge 35 of sleeve 29 may have or define a shape selected from circles, ovals (e.g., ellipsoid shapes), polygons (e.g., triangles, rectangles, squares, pentagons, hexagons, heptagons, octagons, etc), irregular shapes (e.g., combinations of oval and polygonal shapes) and combinations thereof. Open top 26 of bowl 11 and lower edge 35 of sleeve 29 may each have the same or different shapes. For example, both open top 26 and lower edge 35 may be substantially circular, or open top 26 may be substantially square while lower edge 25 is substantially circular.

Each container of the vertical stack of the food container assembly of the present invention may have the same or different dimensions and/or shapes. Preferably, each container within a vertical stack has substantially equivalent dimensions, and accordingly substantially equivalent shapes.

The container may be dimensioned such that sleeve 29 and/or bowl bottom 14 provide sufficient support for bowl 11, and interior space (or volume) 20 of bowl 11 is large enough to contain a desired amount of food 44. For example, in an embodiment of the present invention, interior space 20 of bowl 11 is dimensioned to contain 236 ml (1 cup) of dry granulated food 44. In some instances, it is desirable to provide some head-space between the upper level of food 44 and interior surface 147 of removable polymer film 47 within interior space 20. As such, the volume of interior space 20 may be greater than the volume of food 44 contained therein. For example, when dimensioned to contain 236 ml (1 cup) of dry granulated food 44, bowl 11 may have an interior space 20 having a volume of 354 ml (1.5 cups).

In an embodiment of the present invention and as discussed previously herein, open top 26 of bowl 11 has a substantially circular shape, sleeve 29 is substantially conical and continuous and extends downwardly and outwardly from upper rim 23, lower edge 35 of sleeve 29 has a substantially circular shape, and the outer surface 126 of bowl 11 and the inner surface 124 of sleeve 29 together define an annular space 129 which is substantially conical in shape. With further reference to FIG. 2, the container of this particular embodiment may have the following dimensions: upper rim 23 has an outer diameter 159 of 15.24 cm (6 inches), an inner diameter 162 of 12.70 cm (5 inches), and a width 165 of 1.27 cm (0.5 inches); and lower edge 35 of sleeve 29 has a diameter 156 of 17.78 cm (7 inches).

Sleeve 29 of food container 1 may have a label affixed to exterior surface 32 thereof. The label may be affixed to at least a portion of exterior surface 32 by means of an adhesive, which may be selected from art-recognized adhesives. The label typically has indicia applied thereto, which may be selected from those examples recited previously herein (e.g., letters, numbers and/or barcodes).

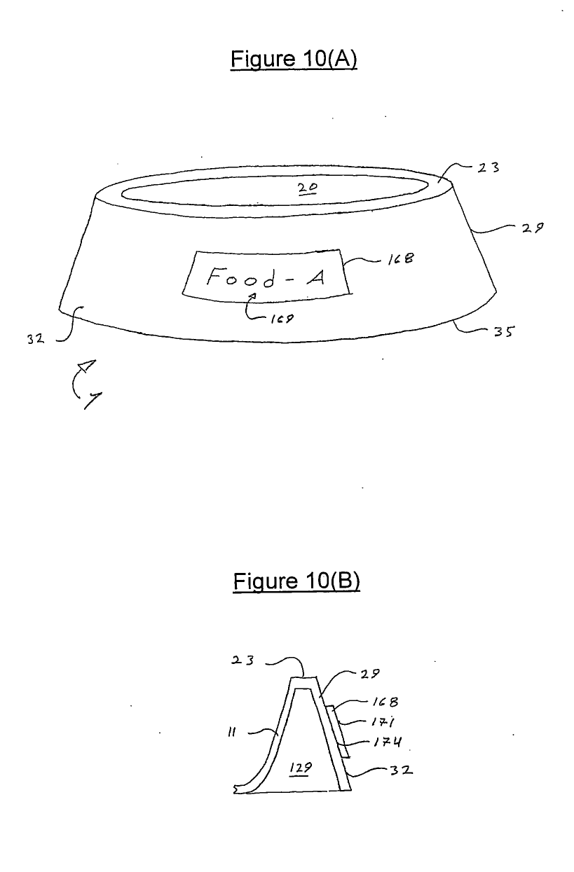

In an embodiment of the present invention and with reference to FIGS. 10(A) and 10(B), sleeve 29 is fabricated from plastic material, and at least a portion of exterior surface 32 thereof is defined by a polymer film 168. Polymer film 168 is an in-mold polymer film that is affixed to exterior surface 32 of sleeve 29 during mold formation of sleeve 29 (and typically mold formation of container 1). Polymer film 168 has a first surface 171 and a second surface 174. Second surface 174 abuts exterior surface 32 of sleeve 29, and first surface 171 defines at least a portion of the outer surface of sleeve 29. Polymer film 168 may have indicia 169 on first surface 171 and/or second surface 174. Indicia 169 may be selected from those examples recited previously herein (e.g., letters, numbers, symbols, designs and/or barcodes).

Polymer film 168 may be a single or multilayered polymer film, and may be fabricated from thermoset and/or thermoplastic polymer materials selected from those examples recited previously herein. Polymer film 168 may be present as part of sleeve 29 for purposes of providing: (i) labeling to sleeve 29; and/or (ii) dimensional stability to sleeve 29. For example, when label 168 defines at least a majority, and more typically substantially all of the exterior surface of sleeve 29, the thickness of sleeve 29 and the amount of plastic material used to fabricate sleeve 29 may be reduced, thus resulting in container 1 having reduced weight.

As discussed previously herein, polymer film 168 is an in-mold polymer film that is fixed to exterior surface 32 of sleeve 29 during mold formation of sleeve 29. Typically, polymer film 168 is placed in the mold such that first surface 171 thereof abuts at least a portion of the interior surface of the mold in which sleeve 29 is formed. Plastic material is introduced into the mold (e.g., by reaction injection molding, injection molding, thermoforming or vacuum forming methods), and the introduced plastic material contacts and fuses and/or covalently bonds to second surface 174 of polymer film 168. In the case of reaction injection molding, reactive components are injected into the mold in the form of a liquid, which react and form a molded article, as discussed previously herein. In the case of injection molding, thermoplastic material is introduced into the mold in a molten form, is cooled and hardens to form the molded article. In the case of thermoforming and vacuum forming methods, thermoplastic material is drawn into the mold at a temperature above the Tg but less than the melting point thereof, and allowed to cool and harden, thereby forming the molded article. Upon removing container 1 from the mold, polymer film 168 is fixed to at least a portion of exterior surface 32 of sleeve 29.

In a further embodiment of the present invention and with reference to FIG. 16, at least a portion of outer surface 32 of sleeve 29 (which may be fabricated from plastic material) is defined by a polymer film 228 that is affixed to outer surface 32 by art-recognized shrink-wrapping methods. More particularly, polymer film 228 is formed from an oriented polymer film, preferably a biaxially oriented thermoplastic polymer film, that has been shrink-wrap applied to outer surface 32 of sleeve 29 by exposure to elevated temperature. For example, polymer film 228 may be formed from a biaxially oriented thermoplastic polypropylene film. Shrink-wrap applied polymer film 228 typically encompasses the perimeter of sleeve 29. In addition, polymer film 228 may include perforations (not shown) that allow for easy removal of film 228 from sleeve 29, for example, prior to recycling container 1. Application of polymer film 228 to outer surface 32 of sleeve 29 is generally achieved by art-recognized methods, and typically involves positioning (e.g., sliding) a biaxially oriented thermoplastic polymer film over outer surface 32, and exposing the positioned biaxially oriented thermoplastic film to elevated temperature (e.g., by applying forced hot air from a heat gun over the exterior surface of the biaxially oriented thermoplastic film), thereby causing the film to shrink and thus become tensionally fixed to outer surface 32 as shrink-wrap applied polymer film 228.

Shrink-wrap applied polymer film 228 may have indicia 231 applied to the interior or exterior surfaces thereof by art-recognized methods. Indicia 231 may be applied prior to and/or after the shrink-wrap application of film 228 to outer surface 32 of sleeve 29. Indicia 231 may be selected from those examples recited previously herein (e.g., letters, number symbols, designs and/or barcodes).

Shrink-wrap applied polymer film 228 may be a single or multilayered polymer film. Typically, polymer film 228 is a single layer thermoplastic polymer film fabricated from thermoplastic polymer materials selected from those examples recited previously herein, and in particular thermoplastic polyolefins, such as thermoplastic polypropylene. Shrink-wrap applied polymer film 228 is usually applied to outer surface 32 for purposes of providing sleeve 29 with labeling (e.g., as to the contents of the food container).

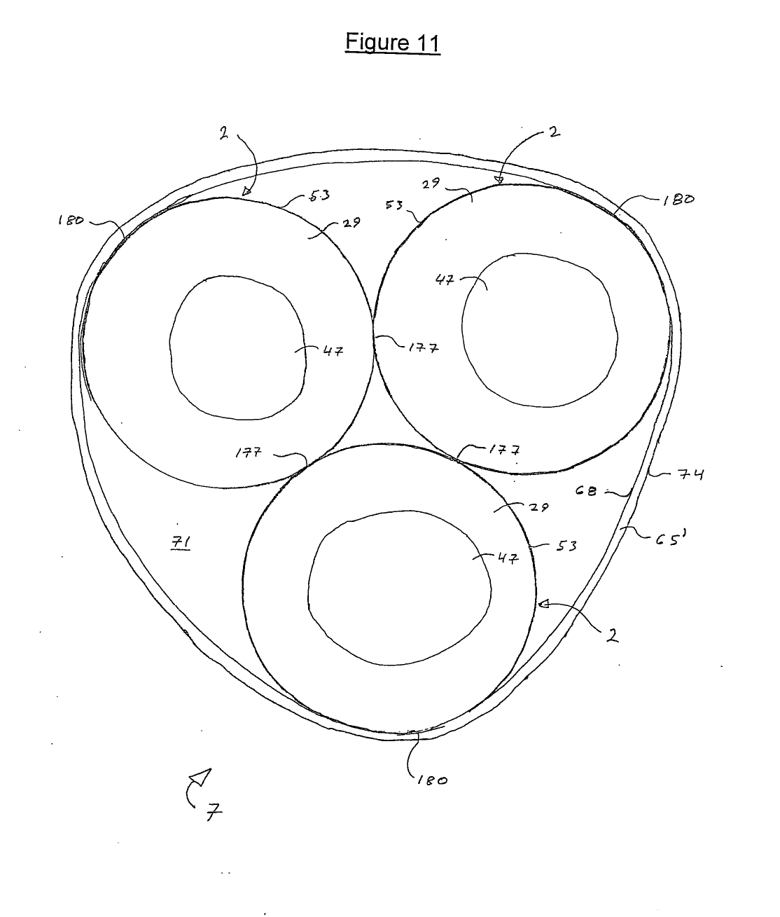

The vertical stack (e.g., vertical stack 2) may, in an embodiment of the present invention comprise a plurality of separate vertical stacks, that are laterally positioned relative to each other within the interior space of the tubular receptacle. The number of vertical stacks of the plurality of vertical stacks may vary, for example ranging from 2 to 10, 2 to 5 or 2 to 4 vertical stacks (e.g., 3 vertical stacks). With reference to FIG. 11, food container assembly 7 includes 3 separate vertical stacks 2 that are laterally positioned relative to each other within interior space 71 of tubular receptacle 65′. A further portion 177 of the outer edge 53 of each vertical stack abuts a further portion 177 of the outer edge 53 of at least one other vertical stack 2, thereby maintaining each vertical stack 2 vertically oriented within interior space 71 of tubular receptacle 65′. At the same time, a portion (e.g., a first portion) 180 of outer edge 53 of each vertical stack 2 abuts a portion of interior surface 68 of tubular receptacle 65′. More particularly, each vertical stack 2 is maintained vertically oriented by a combination of: (i) the mutual abutment of a portion 177 of the outer edge 53 of the vertical stacks 2 with each other; and (ii) the abutment of a portion 180 of the outer edge 53 of each vertical stack 2 with a portion of the interior surface 68 of tubular receptacle 65′. Tubular receptacle 65′ of FIG. 11 has a generally triangular cross-sectional shape, in which the corners of the triangle are rounded.

The containers of the vertical stack of the food container assembly may be arranged so as to provide a sequence of food servings, wherein the sequence of food servings matches the sequence (or order) in which each container is removed from the top of the vertical stack. With reference to FIGS. 3 and 5, vertical stack 2 of food container assembly 4 has a top 204 and a bottom 207, and the plurality of containers 1, 1′, 1″ and 1″′ in vertical stack 2 are arranged sequentially from top 204 to bottom 207 so as to provide a sequence of food servings as each container 1 is removed from the top 204 of vertical stack 2. The sequence of food servings may relate to the amount and/or type of food 44 within each container 1. As such, at least two of the plurality of containers (e.g., 1, 1′, 1″ and 1′″) within vertical stack 2 may have a difference there-between selected from a different amount of food 44 and/or a different type of food 44. For example, containers 1, 1′, 1″ and 1′″ may each contain a different type of food 44 so as to provide a consumer with different food servings that may be consumed at different times over a given period of time (e.g., in 3 hour intervals over a 12 hour period in a single day).

When the food container assembly includes a plurality of vertical stacks (e.g., as described previously herein with reference to FIG. 11), separate sequences of food servings may be provided over a period of several days. For example, the containers of each separate vertical stack may be arranged sequentially so as to provide a sequence of food servings (as described above) within a given vertical stack, and each vertical stack has a sequence designation (e.g., day of the week). The sequence designation of a particular vertical stack may be provided in the form of a label affixed to the removable polymer film of at least the upper most container of that particular vertical stack. For example, on Monday a consumer may sequentially consume the food, throughout the day, provided in the containers of a vertical stack having the sequence designation of “Monday”, and then similarly throughout the remaining days of the week.

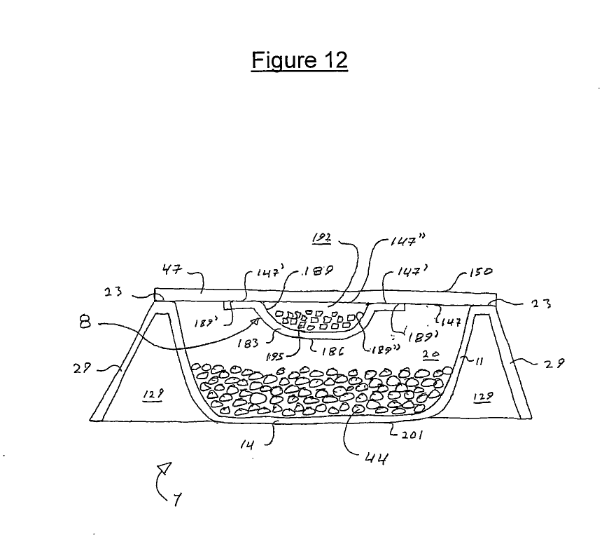

The interior surface of the removable polymer film of the container may optionally include a sealed pouch 8 containing an edible material (e.g., vitamins), in an embodiment of the present invention. With reference to FIG. 12, removable polymer film 47 has a second (or interior) surface 147 facing bowl interior 20. Removable polymer film 47 further includes a second polymer film 183 having a first surface 189 and a second surface 186. Second surface 186 of second polymer film 183 faces interior space 20 of bowl 11. A first portion 189′ of first surface 189 of second polymer film 183 sealingly abuts a first portion 147′ of second surface 147 of removable polymer film 47. A second portion 147″ of second surface 147 of removable polymer film 47 and a second portion 189″ of first surface 189 of second polymer film 183 together define a sealed pouch space 192 that includes an edible material 195. Edible material 195 contained within sealed pouch space 192 is sealingly separated from amount of food 44 contained within bowl interior 20 of bowl 11. Edible material 195 may be selected from vitamins, herbs, spices, flavorings, medicines and combinations thereof.

Second polymer film 183 may be a single or multilayered film, and may be fabricated from film materials as described and discussed previously herein. Sealed pouch 8 may be attached to second surface 147 by means of an interposed adhesive (not shown) or heat-sealing. Removable polymer film 47 may be a multilayered film in which first surface 150 is defined by a heat resistant film layer (e.g., comprising high density polyethylene) and second surface 147 is defined by a heat sealable film layer (e.g., comprising linear low density polyethylene). Second polymer film 183 may be a multilayered film in which first surface 189 is defined by a heat sealable film layer (e.g., comprising linear low density polyethylene) and second surface 186 is defined by a heat resistant layer (e.g., comprising high density polyethylene). As such, with the heat sealable layers of removable polymer film 47 and second polymer film 183 so configured, the two films may be readily heat sealed together to form sealed pouch 8.

Sealed pouch 8 may be formed by orienting removable polymer film 47 with second surface 147 facing up. An amount of edible material 195 is then deposited on a localized area of second surface 147. Portions 189′ of the first surface 189 of second polymer film 183 are brought into abutting contact with portions 147′ of second surface 147 of removable polymer film 47 so as to cover the amount of edible material 95 previously deposited on second surface 147. The abutting portions are then heat-sealed together by the application of elevated temperature and pressure in accordance with art-recognized methods, thereby forming sealed pouch 8 having edible material 195 sealed within sealed pouch space 192 thereof.

Providing the interior surface 147 of removable polymer film 47 with a sealed pouch 8 containing edible material 195, may be desirable for purposes of keeping edible material 195 proximate to but separately sealed from (i.e., not in contact with) food 44 within bowl 11. Such separate containment may be desirable when contact between edible material 195 and food 44 would result in degradation and/or inactivation of either or both. For example, when edible material 195 is a medicine, premature and extended contact thereof with food 44 may degrade and/or inactivate the medicine, e.g., due to oxidation or other chemical reactions there-between.

Maintaining edible material 195 proximate to but separated from food 44, by means of pouch 8, allows a consumer to contact edible material 195 with food 44 just prior to consuming or serving food 44. For example, a portion of first surface 150 of removable film 47 residing over pouch 8 may be gripped between the thumb and index finger of a consumer, pulled upward, and then quickly released allowing film 47 and pouch 8 to snap back down with sufficient force to cause second film 183 of pouch 8 to rupture, thus depositing edible material 195 onto at least a portion of food 44. Container 1 may then be shaken to further distribute edible material 195 throughout food 44. Alternatively, a consumer may at least partially separate removable polymer film 47 from upper rim 23, and then open pouch 8 (e.g., by tearing it), thus allowing edible material 195 to contact food 44.

To assist opening pouch 8, pouch 8 my include a tab (not shown) attached to a portion of second surface 186 of second film 183. Alternatively, a portion of second film 183 may extend non-fixedly past the point where second film 183 is fixedly attached to second surface 147 of removable film 47, thereby effectively forming a tab (not shown) that is continuous with second film 183. The tab my be gripped and pulled away from second surface 147, thereby opening pouch 8, and allowing edible material 195 to be deposited onto food 44.

Upon removal from the tubular receptacle, each food container is typically placed on a support surface, for example, a substantially horizontal support surface, such as the surface of a table (e.g., in the case of human consumption) or on the surface of a floor (e.g., in the case of consumption by a non-human animal, such as a pet). For purposes of reducing, minimizing or substantially preventing lateral movement (or slippage) of the container across the horizontal support surface while in use (e.g., while consuming food therefrom), the exterior surface of the closed bottom of the bowl may be provided with an anti-slip means. The anti-slip means reduces lateral movement or slippage of the container relative to an equivalent container that does not include the anti-slip means. For example, when placed on a test surface in which one end thereof is raised through an arc of several degrees (e.g., 30°, 45° or 60°), a container having the anti-slip means will remain stationary (i.e., will not slip or slide) through a larger arc angle than an equivalent container that does not include the anti-slip means.

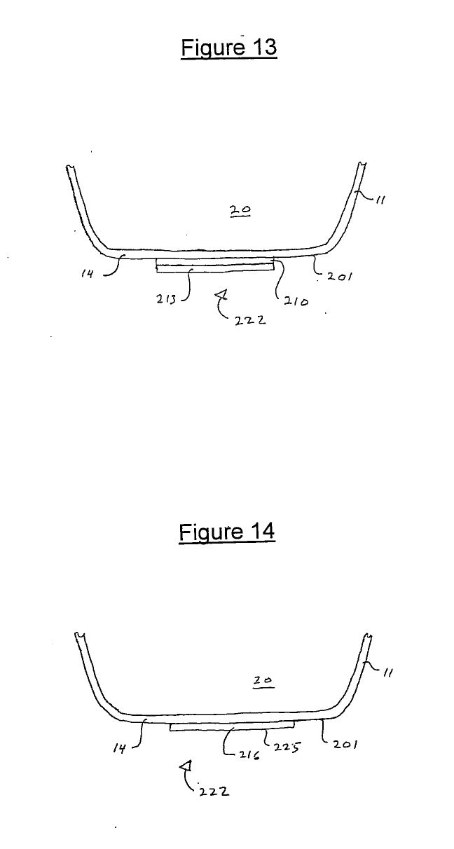

More particularly and with reference to FIGS. 13, 14 and 15, closed bottom 14 of bowl 11 has an exterior surface 201 which comprises a means (e.g., an anti-slip means) 222 of minimizing lateral movement of container 1 on a substantially horizontal support surface (not shown). Means 222 may be selected from: (i) an adhesive 210 interposed between exterior surface 201 of closed bottom 14 of bowl 11 and a removable protective film 213; (ii) at least a portion of exterior surface 201 of closed bottom 14 of bowl 11 being defined by a substantially non-slip elastomeric material 216; (iii) exterior surface 201 of closed bottom 14 of bowl 11 being an irregular surface 219; and (iv) combinations of at least two of (i), (ii) and (iii). As used herein and in the claims, and unless otherwise indicated, the term “irregular surface” means a surface that is not smooth and which has a regular or irregular pattern of raised features (e.g., peaks) and/or recessed features (e.g., valleys).

With further reference to FIG. 13, adhesive 210 may be selected from known adhesives, such as polyurethane adhesives. Removable protective film 213 may be prepared from materials that reversibly adhere to adhesive 210, such as waxed paper, silicone films, or silicone treated materials such as silicone treated paper. Protective film 213 prevents the containers within a vertical stack from sticking to each other. After removal of a container from a vertical stack, protective film 213 may be removed, thus exposing the underlying adhesive layer 210. The container may then be placed on a support surface, such as the surface of a horizontal table, such that adhesive layer 210 contacts a portion of the horizontal surface, thus substantially preventing lateral movement (e.g., slippage) of the container across the support surface when in use.

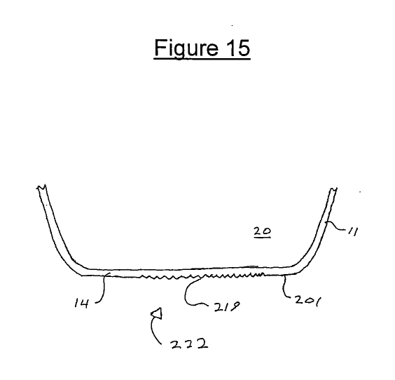

With reference to FIG. 14, non-slip elastomeric material (or layer) 216 may be selected from known elastomeric materials having non-slip properties, but at the same time a minimum of and preferably essentially no adhesive properties (so as to prevent the containers sticking together in a vertical stack). Examples of elastomeric materials from which non-slip elastomeric layer 216 may be fabricated include, but are not limited to, natural rubbers, nitrile rubbers, polydiene rubbers (e.g., polybutadiene rubbers) and combinations thereof. Non-slip elastomeric layer 216 may be fixed to exterior surface 201 of closed bottom 14 by means of an adhesive interposed there-between (not shown). Alternatively, non-slip elastomeric layer 216 may be fixed to exterior surface 201 by means of art-recognized in-mold application methods. For example, non-slip layer 216 is placed against the interior surface of a mold, and the plastic material of bowl 11 is introduced into the mold and becomes bonded or fused to non-slip layer 216. Upon removal of the container from the mold, non-slip layer 216 is affixed to and defines at least a portion of exterior surface 201 of closed bottom 14 of bowl 11. The exterior surface 225 of non-slip elastomeric layer 216 may be an irregular surface, for example, having one or more patterns of raised features and/or recessed features imprinted therein (not shown).

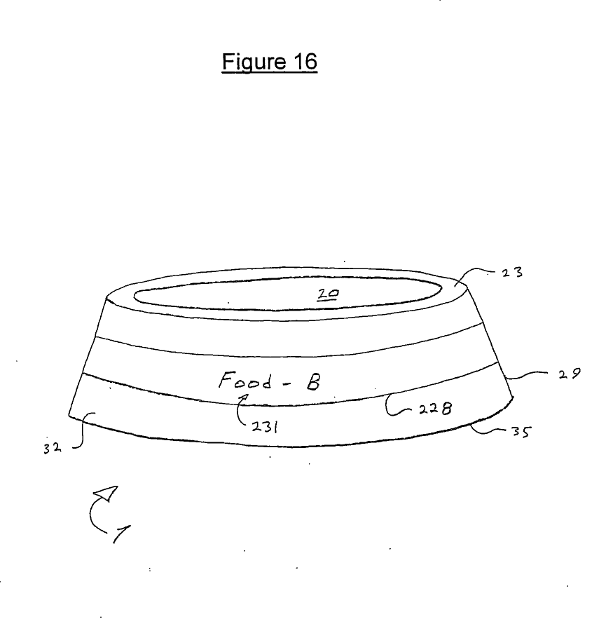

With reference to FIG. 15, irregular surface 219 may be formed prior to or after mold formation of the container. For example, irregular surface 219 may be formed by scoring or etching exterior surface 201 after mold formation of the container. Alternatively, or in addition thereto, at least a portion of the mold surface against which exterior surface 201 of closed bottom 14 is formed, may be provided with a 3-dimensional pattern having raised and/or recessed features that serve to form irregular surface 219 when plastic material is molded there-against.

The present invention has been described with reference to specific details of particular embodiments thereof. It is not intended that such details be regarded as limitations upon the scope of the invention except insofar as and to the extent that they are included in the accompanying claims.

What is claimed is:

1. A food container assembly comprising:
(a) a plurality of containers each comprising:
(i) a bowl having a closed bottom, an inner surface defining a bowl interior, and an upper rim defining an open top;
(ii) a sleeve having an outer surface and a lower edge, and extending downwardly from said upper rim of said bowl;
(iii) an amount of food residing in said bowl interior; and
(iv) a removable polymer film sealingly engaging said upper rim of said bowl, thereby sealing said open top of said bowl and containing said amount of food within said bowl interior;
wherein said plurality of containers are arranged in a vertical stack, said vertical stack having an outer edge; and
(b) a tubular receptacle having a closed bottom, a closed top, and a sidewall having an interior surface defining an interior space, said tubular receptacle being substantially continuous and being resistant to oxygen permeation therethrough, and said interior space being a substantially sealed interior space;
wherein said vertical stack resides within said interior space of said tubular receptacle, and at least a portion of said outer edge of said vertical stack abutting a portion of said inner surface of said sidewall.

2. The food container assembly of claim 1 wherein said bowl of each container has an outer surface,
said sleeve extends downwardly and outwardly from said upper rim of said bowl, a portion of said outer surface of said bowl and an inner surface of said sleeve together defining an annular space, and said lower edge of said sleeve extending laterally out beyond said upper rim of said bowl and defining an outer lateral edge of said container, and
said outer lateral edge of each container being substantially vertically aligned and together defining said outer edge of said vertical stack.

3. The food container assembly of claim 2 wherein said open top of said bowl is a circular open top, said sleeve is a conical sleeve, said lower edge of said sleeve is a circular lower edge, and said annular space is a conical annular space.

4. The food container assembly of claim 2 wherein said vertical stack comprises at least one of,
a first pair of neighboring containers in which said lower edge of each of said first pair of neighboring containers abut each other, and
a second pair of neighboring containers in which each upper rim of each of said second pair of neighboring containers are substantially aligned and said removable polymer film of each of said second pair of neighboring containers are adjacent to each other.

5. The food container assembly of claim 4 further comprising a blocking resistant film residing between each second pair of neighboring containers, said removable polymer film of each of said second pair of neighboring containers abutting said blocking resistant film.

6. The food container assembly of claim 1 wherein said vertical stack comprises a plurality of vertical stacks, said plurality of vertical stacks being laterally positioned relative to each other within said interior space of said tubular receptacle, and a further portion of the outer edge of each vertical stack abutting a further portion of the outer edge of at least one other vertical stack, thereby maintaining each vertical stack vertically oriented.

7. The food container assembly of claim 1 wherein said outer edge of said vertical stack slidingly abuts said portion of said inner surface of said sidewall.

8. The food container assembly of claim 1 wherein said vertical stack has a top and a bottom, and said plurality of containers are arranged sequentially from said top to said bottom of said vertical stack so as to provide a sequence of food servings.

9. The food container assembly of claim 8 wherein at least two of said plurality of containers of said vertical stack have a difference selected from the group consisting of a different amount of food, a different type of food and combinations thereof.

10. The food container assembly of claim 1 wherein each container further comprises an adhesive interposed between said upper rim of said bowl and said removable polymer film.

11. The food container assembly of claim 1 wherein said open top of said bowl has a shape selected from the group consisting of circles, ovals, polygons, irregular shapes and combinations thereof, and said lower edge of said sleeve has a shape selected from the group consisting of selected from the group consisting of circles, ovals, polygons, irregular shapes and combinations thereof.

12. The food container assembly of claim 1 wherein each container has equivalent dimensions.

13. The food container assembly of claim 1 wherein said bowl and said sleeve are each independently fabricated from a plastic material.

14. The food container assembly of claim 13 wherein said plastic material is selected from the group consisting of thermosetting plastic materials, thermoplastic materials and combinations thereof.

15. The food container assembly of claim 14 wherein said plastic material is a thermoplastic material selected from the group consisting of thermoplastic polyurethane, thermoplastic polyurea, thermoplastic polyimide, thermoplastic polyamide, thermoplastic polyamideimide, thermoplastic polyester, thermoplastic polycarbonate, thermoplastic polysulfone, thermoplastic polyketone, thermoplastic polyolefin, thermoplastic acrylonitrile-butadiene-styrene and combinations thereof.

16. The food container assembly of claim 13 wherein the plastic material of said sleeve comprises a reinforcing material, and the plastic material of said bowl is substantially free of reinforcing material.

17. The food container assembly of claim 16 wherein said reinforcing material is selected from the group consisting of glass fibers, glass beads, carbon fibers, metal flakes, polyamide fibers, nanoparticulate clays, talc and mixtures thereof.

18. The food container assembly of claim 1 wherein said sleeve is fabricated from a plastic material, and at least a portion of said outer surface of said sleeve is defined by a polymer film, said polymer film being an in-mold polymer film affixed to said sleeve during molding of said sleeve.

19. The food container assembly of claim 18 wherein said in-mold polymer film has a first surface and a second surface, said second surface of said in-mold polymer film abutting said sleeve and said first surface of said in-mold polymer film defining at least a portion of said outer surface of said sleeve, and
said in-mold polymer film further comprising indicia on at least one of said first surface and said second surface.

20. The food container assembly of claim 1 wherein at least a portion of said outer surface of said sleeve is defined by a polymer film, said polymer film being affixed to said outer surface of said sleeve by shrink wrapping.

21. The food container assembly of claim 1 wherein said removable polymer film has a second surface facing said bowl interior, said removable polymer film further comprising a second polymer film having a first surface and a second surface, a first portion of said first surface of said second polymer film sealingly abutting a first portion of said second surface of said removable polymer film, said second surface of said second polymer film facing said bowl interior, a second portion of said second surface of said removable polymer film and a second portion of said first surface of said second polymer film together defining a sealed pouch space, said sealed pouch space comprising an edible material, and said edible material being sealingly separated from said amount of food.

22. The food container assembly of claim 21 wherein said edible material is selected from the group consisting of vitamins, herbs, spices, flavorings, medicines and combinations thereof.

23. The food container assembly of claim 1 wherein said removable polymer film has a first surface and a second surface, a portion of said second surface sealingly abutting said upper rim of said bowl, said removable polymer film further comprising a tab fixedly attached to said first surface.

24. The food container assembly of claim 1 wherein said removable polymer film is a multilayer polymer film comprising,
(a) a heat seal resistant layer, superposed over
(b) a heat sealable layer, said heat sealable layer sealingly abutting said upper rim of said bowl.

25. The food container assembly of claim 24 wherein,
said heat seal resistant layer comprises a thermoplastic material
selected from the group consisting of high density polyethylene, medium density polyethylene, polypropylene, polyamides, polyesters, polyacrylonitrile, polyvinylidene chloride, and combinations thereof; and
said heat sealable layer comprises a thermoplastic material selected from the group consisting of polyethylene homopolymers, polyethylene copolymers prepared from ethylene and at least one C₃-C₁₂ alpha-olefin, copolymers of ethylene and styrene, ethylene vinyl acetate copolymers, ethylene methacrylate copolymers, ethylene acrylic acid copolymers, ethylene methacrylic acid copolymers, copolymers of hexene and butene, polybutylene, ionomers, acid anhydride modified ethylene vinyl acetate copolymers, and combinations thereof.

26. The food container assembly of claim 24 wherein,
said heat seal resistant layer comprises a thermoplastic material
selected from the group consisting of high density polyethylene, medium density polyethylene, polypropylene, polyamides, polyesters, polyacrylonitrile, polyvinylidene chloride, and combinations thereof; and
said heat sealable layer comprises an immiscible blend of thermoplastic polymers comprising:
(a) a first polymer, forming a substantially continuous phase, selected from the group consisting of polyethylene homopolymers, polyethylene copolymers prepared from ethylene and at least one C₃-C₁₂ alpha-olefin, copolymers of ethylene and styrene, ethylene vinyl acetate copolymers, ethylene methacrylate copolymers, ethylene acrylic acid copolymers, ethylene methacrylic acid copolymers, copolymers of hexene and butene, ionomers, acid anhydride modified ethylene vinyl acetate copolymers, and combinations thereof; and
(b) a second polymer, forming a substantially discontinuous phase, selected from the group consisting of polybutylene, polypropylene homopolymers, polypropylene copolymers prepared from propylene and at least one C₂-C₁₂ alpha-olefin exclusive of propylene, high density polyethylene, crosslinked polyethylene, and combinations thereof;
provided the first polymer (a) and the second polymer (b) are different polymers.

27. The food container assembly of claim 1 wherein said tubular receptacle has a haze value of less than 15 percent, and a transparency value of greater than 50 percent.

28. The food container assembly of claim 1 further comprising at least one handle fixedly attached to said tubular receptacle.

29. The food container assembly of claim 1 wherein said tubular receptacle further comprises at least one reversibly sealable opening.

30. The food container assembly of claim 29 wherein said reversibly sealable opening is located in said top of said tubular receptacle.

31. The food container assembly of claim 1 wherein said tubular receptacle has a cross sectional shape selected from the group consisting of circles, ovals, polygons, irregular shapes and combinations thereof.

32. The food container assembly of claim 1 wherein said tubular receptacle has an oxygen permeability value of less than or equal to 1 (cm³/m²/day).

33. The food container assembly of claim 1 wherein said tubular receptacle has a moisture permeability value of less than or equal to 5 (g/m²/day).

34. The food container assembly of claim 1 wherein said tubular receptacle is a multilayer tubular receptacle comprising at least one layer that is resistant to oxygen permeation therethrough.

35. The food container assembly of claim 1 wherein said closed bottom of said bowl has an exterior surface which comprises a means of reducing lateral movement of said container on a substantially horizontal support surface, said means being selected from the group consisting of:
(i) an adhesive interposed between said exterior surface of said closed bottom of said bowl and a removable protective film;
(ii) at least a portion of said exterior surface of said closed bottom of said bowl being defined by a substantially non-slip elastomeric material;
(iii) said exterior surface of said closed bottom of said bowl being an irregular surface; and
(iv) combinations of at least two of (i), (ii) and (iii).
